(19) United States
(12) Patent Application Publication
(10) Pub. No.: US 2014/0358650 A1
(43) Pub. Date: Dec. 4, 2014

(54) SYSTEM AND METHOD FOR EVENT PROMOTION AND FUND RAISING

(71) Applicants: Karen Esther Basian, Toronto (CA); Howard Jeffrey Gold, Toronto (CA)

(72) Inventors: Karen Esther Basian, Toronto (CA); Howard Jeffrey Gold, Toronto (CA)

(21) Appl. No.: 13/907,302

(22) Filed: May 31, 2013

(51) Int. Cl. G06Q 30/02

(52) U.S. Cl. CPC G06Q 30/0279
USPC 705/14.5; 705/329; 705/39

(57) ABSTRACT

A system, computer program product and method configured to stage an event for fund raising or other promotional cause wherein participants are geographically dispersed and/or participation in the event comprises activities spread over a number of venues that are geographically dispersed, or particular locations chosen by the participants, and/or a range of dates.

### FIELD OF THE INVENTION

The present invention relates to computer systems and more particularly, to a system and method for promoting an event/activity and/or providing fund raising for an event.

### BACKGROUND OF THE INVENTION

Traditional fund raising is generally inefficient. Furthermore, with fierce competition for donations, charitable organizations are typically unable to grow profitably.

A charitable event, for instance, a golf tournament, bike ride or contest, requires considerable upfront effort and expenditures, and resources such as project management, volunteers and prizes. Moreover, a charitable event such as a golf tournament is by its very nature limited to a specific date, location and venue capacity. This in turn constrains or limits the fundraising potential of the event. Typically the charitable event is staged annually resulting in duplication of effort year-over-year, and can lead to a stale event and volunteer, donor and sponsor fatigue.

It has been estimated that golf events (bike rides, bowling events, etc.) for charitable causes net only 10-20% for the actual charity.

Accordingly, there remains a need for improvements in the art.

### BRIEF SUMMARY OF THE INVENTION

The present invention is directed to a method and system for staging and/or promoting an event and/or providing fund raising for an event.

According to one embodiment, the present invention comprises a system for staging an event wherein a plurality of participants are geographically dispersed, the system comprises: a server operatively coupled to a communication network and including a participant interface; each of the participants having a computing device configured to interface with the participant interface over the communication network; the server being configured to generate an event property for the event, the event property comprising one or more elements associated with the event, and the event property being configured to allow each of the participants to participate in the event from a location of their choosing, and one of the event property elements comprising a date range for participation in the event by each of the participants; and the server being configured to record the participation of each of the participants.

According to another embodiment, the present invention comprises a computer program product for staging an event wherein a plurality of participants are geographically dispersed, the computer program product comprises: a storage medium configured to store computer readable instructions; the computer readable instructions including instructions for, registering each of the participants for participation in the event; configuring an event property associated with the event, the event property comprising one or more elements associated with the event, and the event property being further configured to allow each of the participants to participate in the event from a location chosen by the participant, and one of the event property elements comprising a date range for participation in the event by each of the participants; and recording the participation of each of the participants.

According to another embodiment, the present invention comprises a method for staging an event, the method comprises the steps of: registering at least some of a plurality of participants for participation in the event; generating an event property associated with the event, the event property comprising one or elements associated with the event, and the event property being configured to allow participants to participate in the event from a location of the participant's choosing, and the event property being configured to include a time horizon for participation in the event by the participants; and recording the participation of each of the registered participants at the selected venue.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 shows in diagrammatic form a system for event promotion and fund raising according to an embodiment of the present invention;

FIG. 2 shows a server for event promotion and fund raising for the system of FIG. 1 according to an embodiment of the present invention;

FIG. 3 shows in diagrammatic form an event property generated by the system of FIG. 1 and features and/or functions associated with the event according to an embodiment of the present invention;

FIG. 4 shows a sequence of screenshots generated by the system of FIG. 1 according to an embodiment of the present invention for participation in the event by a registrant and/or donor;

FIGS. 5(a) to 5(c) show a number of screenshots generated by the system for providing user access;

FIGS. 6(a) to 6(b) show a number of screenshots generated by the system for a member profile for a user;

FIG. 7 shows a screenshot of a landing page generated by the system of FIG. 1 according to an embodiment of the present invention;

FIG. 8 shows a screenshot of an event page generated by the system of FIG. 1 for an event property according to an embodiment of the present invention;

FIGS. 9(a) to 9(b) show screenshots of a registration page and an acknowledgment page generated by the system of FIG. 1 according to an embodiment of the present invention;

FIG. 10 shows a screenshot of a Frequently Asked Questions or FAQ page generated by the system of FIG. 1 according to an embodiment of the present invention;

FIG. 11 shows a screenshot of a Contact page generated by the system of FIG. 1 according to an embodiment of the present invention;

FIG. 12 shows a screenshot of a Coupons and Prizing page generated by the system of FIG. 1 according to an embodiment of the present invention;

FIG. 13 shows a screenshot of a social media page generated by the system of FIG. 1 according to an embodiment of the present invention;

FIG. 14 shows a screenshot of a social media member search page generated by the system of FIG. 1 according to an embodiment of the present invention;

FIGS. 15(a) to 15(b) show screenshots of a social media blogging page generated by the system of FIG. 1 according to an embodiment of the present invention; and

FIG. 16 shows a server for third party event promotion and fund raising according to another embodiment of the present invention;

FIG. 17 shows a screenshot of a landing page for a third party event according to an embodiment of the present invention;

FIG. 18 shows a screenshot of a tournament list page for third party events according to an embodiment of the present invention;

FIG. 19 shows a screenshot of a profile page for a participant according to an embodiment of the present invention;

FIG. 20 shows a screenshot of a home page for a third party event according to an embodiment of the present invention and a screenshot of a personal dashboard page according to an embodiment of the present invention;

FIG. 21 shows a screenshot of a leaderboard for tracking third party events according to an embodiment of the present invention;

FIG. 22 shows a screenshot of a donor and donation leaderboard according to an embodiment of the present invention; and

FIG. 23 shows a donation thermometer for illustrating donation amounts and donation goal.

Like reference numerals indicate like or corresponding elements or components in the drawings.

### DETAILED DESCRIPTION OF THE EMBODIMENTS OF THE INVENTION

Reference is made to FIG. 1, which shows in diagrammatic form an exemplary operating environment and configuration for implementing and practicing a system for event promotion and fund raising according to embodiments of the present invention. The system for event promotion and fund raising operating environment according to an embodiment and indicated generally by reference 100 comprises a client/server configuration operating in the “cloud”, i.e. the Internet, or some other form of networked or coupled configuration. As shown, the system 100 comprises a promotion or event server 120, one or more clients indicated generally by reference 130, and a plurality of participants indicated generally by reference 140. The client(s) 130 and the participants 140 access the server 120, for example, through a network 110. The network 110 may comprise the Internet or the “Cloud”, a local area network (LAN), a wide area network (WAN), a wireless network (WIFI, Bluetooth), or any combination thereof. According to another embodiment or aspect, the system 100 comprises a social media and promotion engine indicated general by reference 150. According to an embodiment, the social media engine 150 comprises interfaces to social media applications, for example, Facebook™, Twitter™, Google+™, as described in more detail below.

The server 120 is configured to create an event property which resides on the server 120. In FIG. 1, the event property is indicated generally by reference 136 and comprises a branded event that is accessible by clients, as described in more detail below. The event property comprises a software module or object created for an event, for example, a charity fund raiser, and includes a logo or other graphics (e.g. to create a branded event), one or more branding components, one or more messaging components, as described in more detail below. According to another aspect, the event property comprises a game (for example, golf) or other activities (for example, bike rides, bowling, photo contests, art contests, etc.) or rules based on a target audience, i.e. participants 140, for promoting a cause and/or raising funds for the cause or charity. Appendix I provides a list of rules for an exemplary golf event for a charity. According to another aspect, the event property includes participation by one or more of the clients 130. The clients 130 may comprise corporate sponsors 142 and/or other vendors who provide prizes and/or other incentives or redeemable items for the participants 140. According to one embodiment, the prizes are converted into electronic coupons which are accessed or awarded through operation of the event property on the server 120, as described in more detail below.

The participants or users 140 comprise individuals who interface with the event property configured on the server 120 and participate in the game for raising funds. The participants comprise donors 142 and may also include personal sponsors 144 who provide sponsorship to other participants through the event property for the cause or charity, as described in more detail below. According to an embodiment, the participants in an event are not tied to a specific venue (e.g. can be geographically dispersed) and the time for playing the event can also spread over time (e.g. over 7 days), as will be described in more detail below. For instance, instead of having a one day charity golf event at a golf course for 144 golfers (i.e. participants), the golf event can spread over 100 golf courses across North America and have 14400 golfers play their round one day out of seven days.

Referring again to FIG. 1, the social media engine 150 is configured to provide the event property with social media and blogging functions, for example, using social media applications such as Facebook™, Twitter™, Google+™, as described in more detail below. According to another aspect, the social media engine 150 is configured to integrate traditional media mechanisms, for example, television, radio and/or print advertising for promotion of the event associated with the event property.

Reference is next made to FIG. 2, which shows a configuration for the server 120 in more detail. According to an embodiment of the invention, the server 120 comprises an event properties module 210, a participant and user profile database 220, a base website pages module 230, a payment module 240, an incentive/coupon module 250, a social media engine module 260 and an analytics and tracking module 270. The modules comprise programs, code modules, software applications and/or objects configured to run on a platform or platforms configured for the server 120.

The event properties module 210 is configured to generate one or more event properties. According to an embodiment, each event property is associated with a cause, a charity or another cause, and comprises components such as trademarks, branding elements, messaging mechanisms, cause data or information, relevant dates, geographical data or information, activity information or definitions, game information or configurations, prizing definitions, incentive definitions, and/or sponsor assignments.

The participant data base 220 is configured to capture and/or store information associated with discrete users. According to one aspect, the participant data base 220 is configured to store a user name, login credentials and a profile for each user (i.e. participant). According to an aspect, the participant data base 220 is configured to allow the server 120 to reuse or transfer user information between separate event properties. The participant may also enhance their profile with additional information.

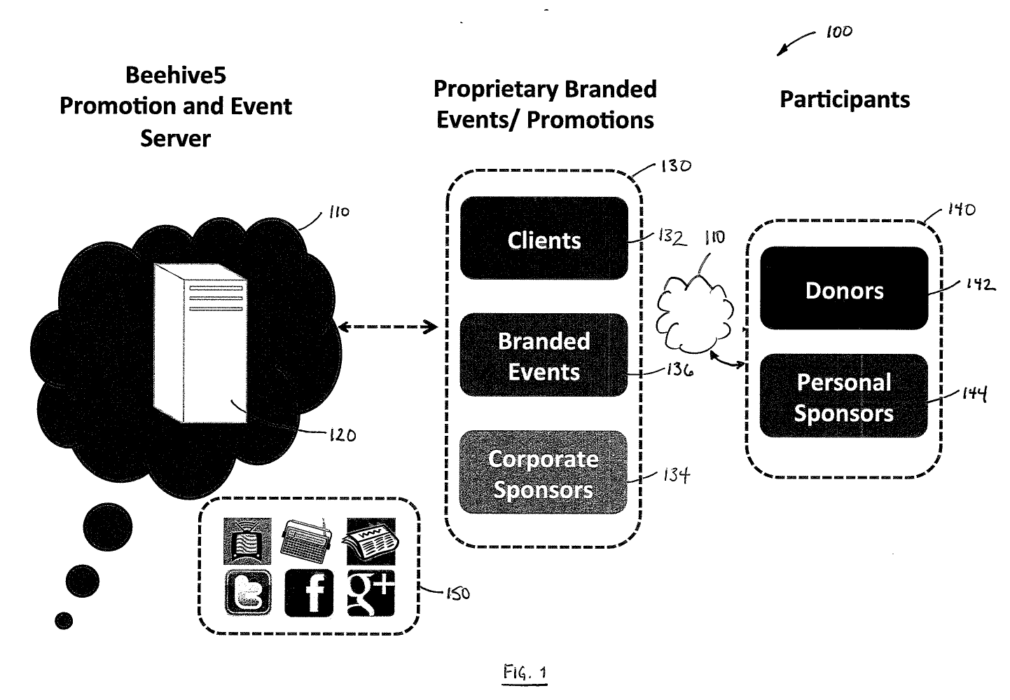

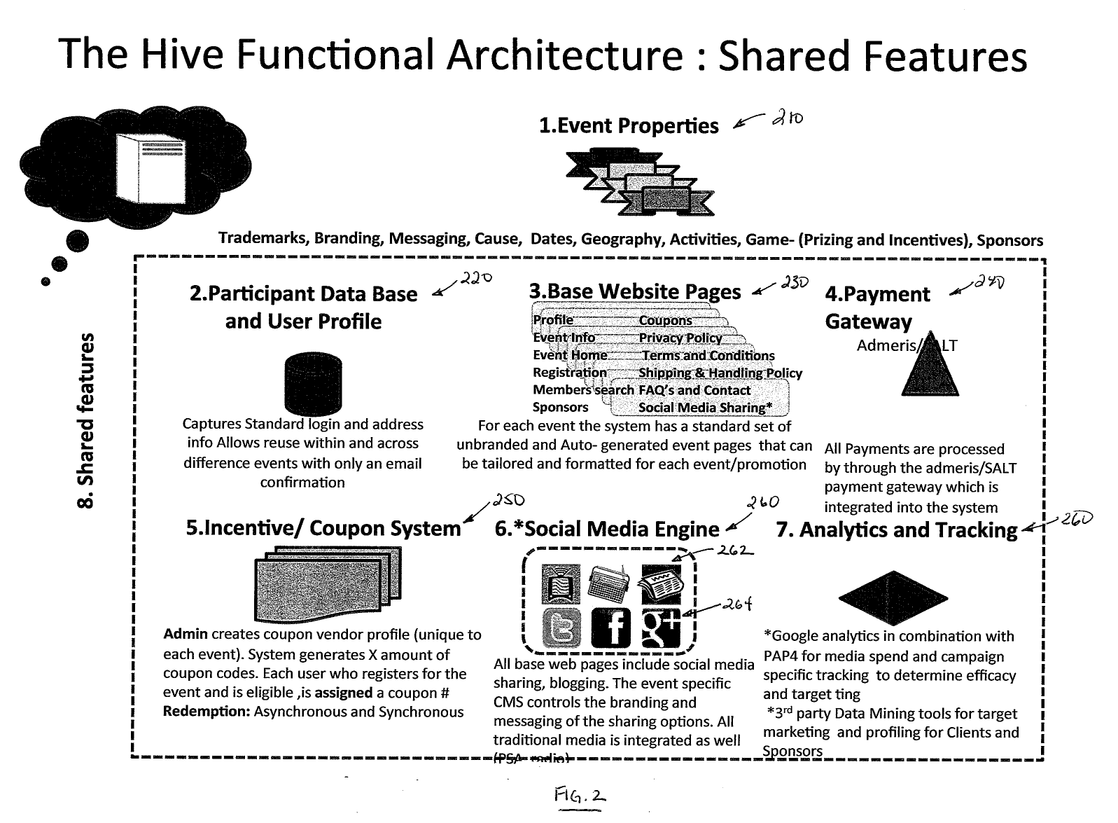

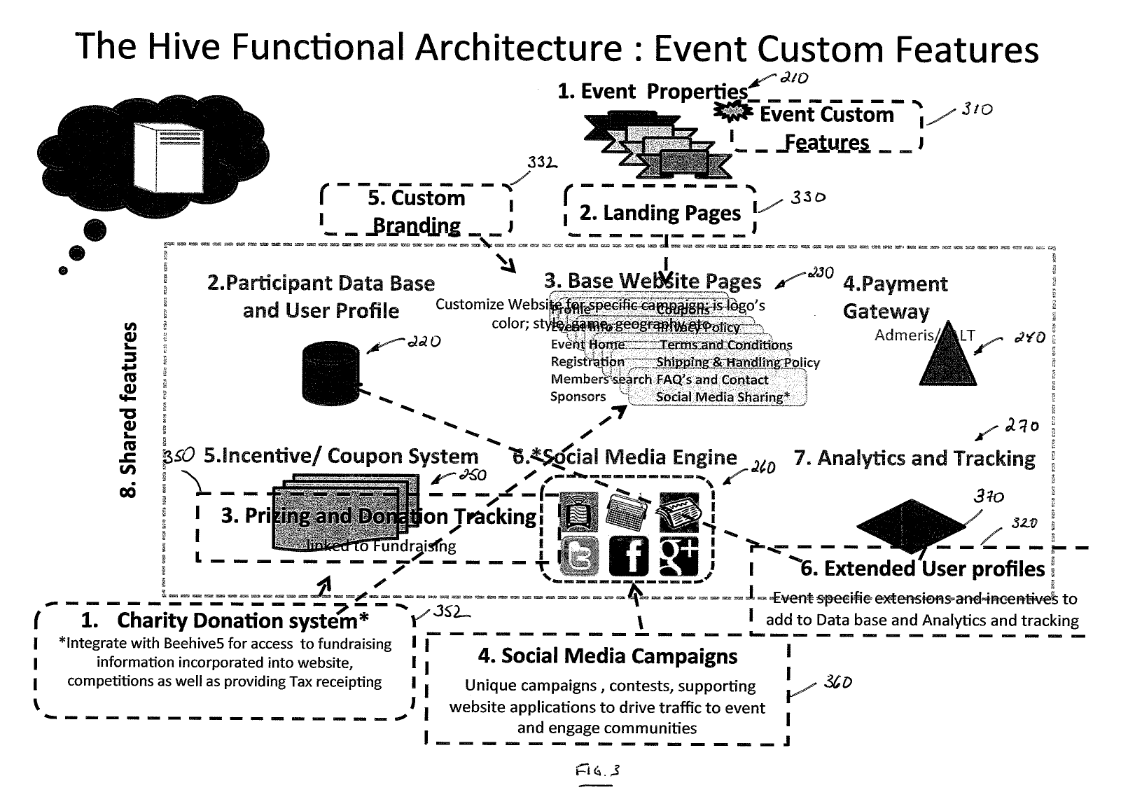

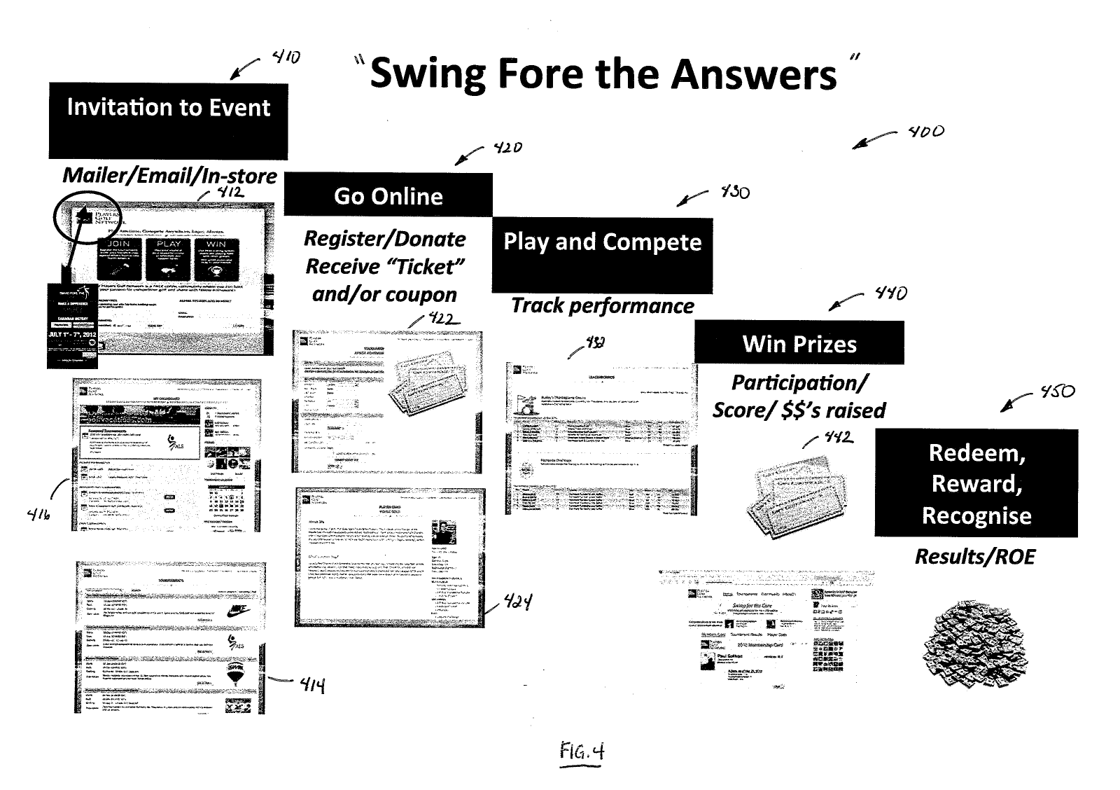

The base website pages module 230 is configured to generate pages, e.g. website pages accessible through a browser application. According to an embodiment, each event property comprises one or more of the following website pages: a profile page, an event info page, an event home page, a registration page, a members search page, a sponsors page, a coupons page, a privacy policy page, a terms and conditions page, a shipping and handling policy page, a FAQ's page and a contact page. FIGS. 4 to 15 show representative website pages (i.e. webpages), as described in more detail below. According to an embodiment, the website pages comprise standard unbranded templates and auto-generated event pages. The server 120 is configured to allow the website pages to be tailored for each event according to the event property for that event. According to another aspect, the website pages are configured to be available both online, i.e. through a conventional browser, and through a mobile device.

The payment module 240 is configured to allow participants to make payments and contributions for events associated with the event properties online via the server 120. According to an exemplary embodiment, the payment module 240 comprises a payment or merchant gateway, for example, the PayPal™ system, the Interact™ system, and/or the Admeris/SALT payment gateway. According to another aspect, the payment gateway 240 is configured to allow participants to make payment online (e.g. utilizing a browser running a computer or other computing device) or via a mobile device (e.g. a smart phone, tablet).

According to an embodiment, each event property includes one or more coupons or incentives provided (e.g. donated) by vendors or corporate sponsors. The incentive/coupon module 250 according to one aspect is configured to allow the server 120 to create, generate and/or assign electronic or virtual coupons. The coupons are assigned to a participant based on eligibility or other rules. According to another aspect, the incentive/coupon module 250 is configured to provide asynchronous redemption and a synchronous redemption for a vendor. For asynchronous redemption, the incentive/coupon module 250 is configured to send or transmit a list of valid coupon codes to the associated vendor. The coupon codes do not include associated participant names, i.e. the coupons have not yet been assigned, and the vendor is tasking with managing the list of coupon codes. For synchronous redemption, each coupon code is assigned to a participant for redemption.

The social media engine 260 is configured according to an embodiment to embed or link base webpages for an event property with social media sharing and blogging controls. According to an exemplary implementation, an event specific CMS controls the branding and messaging of the social media sharing options. According to an embodiment, the social media engine 260 comprises an integrated media module configured for TV, radio and print advertising and promotion as indicated generally by reference 262. It will be appreciated that the social media engine 260 is configured to link and/or integrate an event property with online and mobile social and digital media applications thereby providing a leveraged platform for promotion of the event. For instance, the social media engine 260 is configured to utilize the networks and tools associated with social media applications 264 such as Facebook™, LinkedIn™, Google+™ and/or Twitter™ as part of the online and/or mobile campaign and outreach, prizing and incentive programs, user profiling, targeting, tracking and/or network analysis for one or more the event properties. According to another embodiment, the social media engine 260 is configured to provide a facility for blogging and other communication between participants and members, for example, utilizing a blogging page as depicted in FIG. 15 and described below.

The analytics and tracking module 270 is configured to provide the capability for determining campaign efficacy and targeting. According to an embodiment, the analytics and tracking module 270 utilizes analytics application or suite, for example, Google Analytics, visitor recordings, heatmaps, and ad campaign monitoring dashboards, configured to determine media spend and/or campaign specific tracking. According to another embodiment, the analytics and tracking module 270 comprises tools for micro-optimization of spend and target marketing for an event. According to an embodiment, the analytics and tracking module 270 comprises data mining tools configured for user profiles for designing marketing and promotional programs for specific events (i.e. causes), and/or sponsor programs and incentives, and/or for measuring efficacy and returns of an event and associated activities.

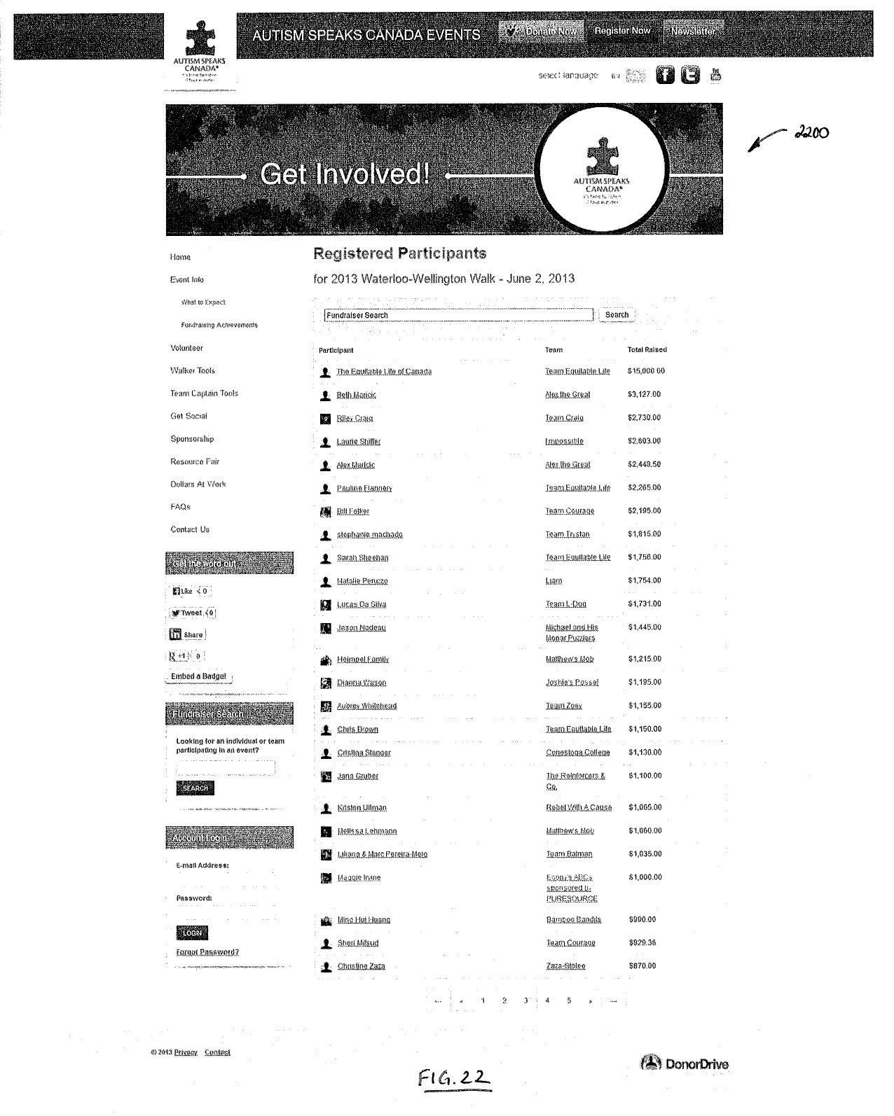

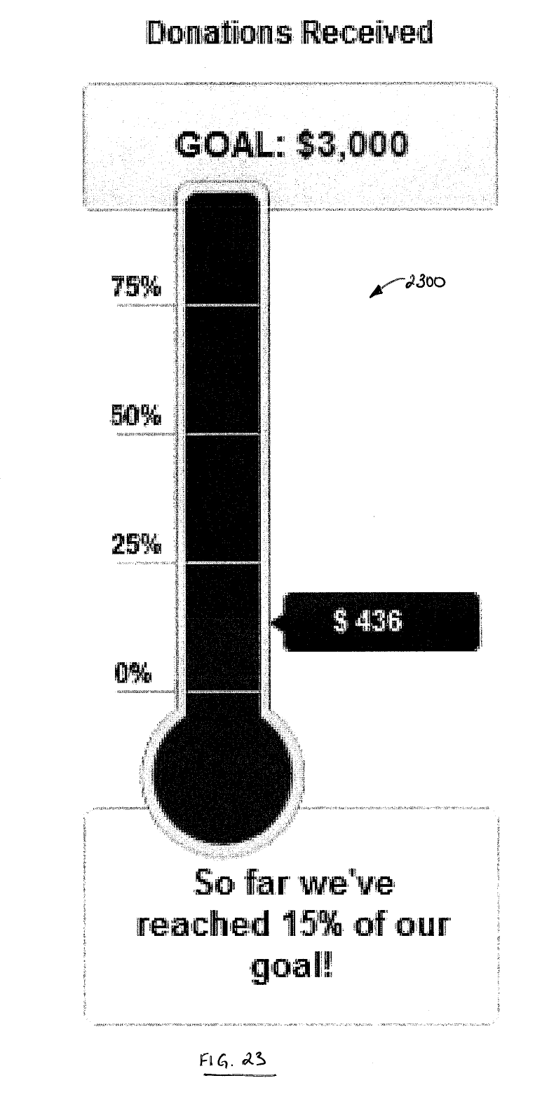

Reference is next made to FIG. 3, which shows the configuration of the functional modules of FIG. 2 for an event property having one or more custom features or associated functions. In the following description, the system is configured for a donation and fund raising system associated with a charity. According to this exemplary embodiment for a donation system, the event properties module 210 for the event property comprises event custom features indicated by reference 310 and includes a donor and donation amount list or leaderboard 2200, for example, as depicted in FIG. 22 and/or a donation “thermometer” 2300, for example, as depicted in FIG. 23. The leaderboard 2200 and the donation thermometer 2300 may be linked directly with the charity. The linked configuration allows a client who wants to raise funds to have direct access through the links on the event webpages. The linking is further configured through the server 120 to allow the charity to manage the donations and tax receipting. According to an embodiment, the server 120 is configured to capture donor information and profiles, for example, dollars raised, leaderboards for events (e.g. golf, funds raised, team ranking), for tracking, competition and/or prizing. According to another aspect, the participant data base module 220 is configured to process data associated with an extended user profile 320, for instance, according to additional parameters and/or metrics to enhance the quality and scope of information stored in the database, indicated generally by reference 320 in FIG. 3. The extended user profile 320 may include event specific extensions and incentives, for instance, information related to past time and interest, demographic information, donation amounts, messaging, event specific gaming or market research information. According to another aspect, the analytics and tracking module 270 is configured to process data from the extended user profile 320 as indicated by link 370.

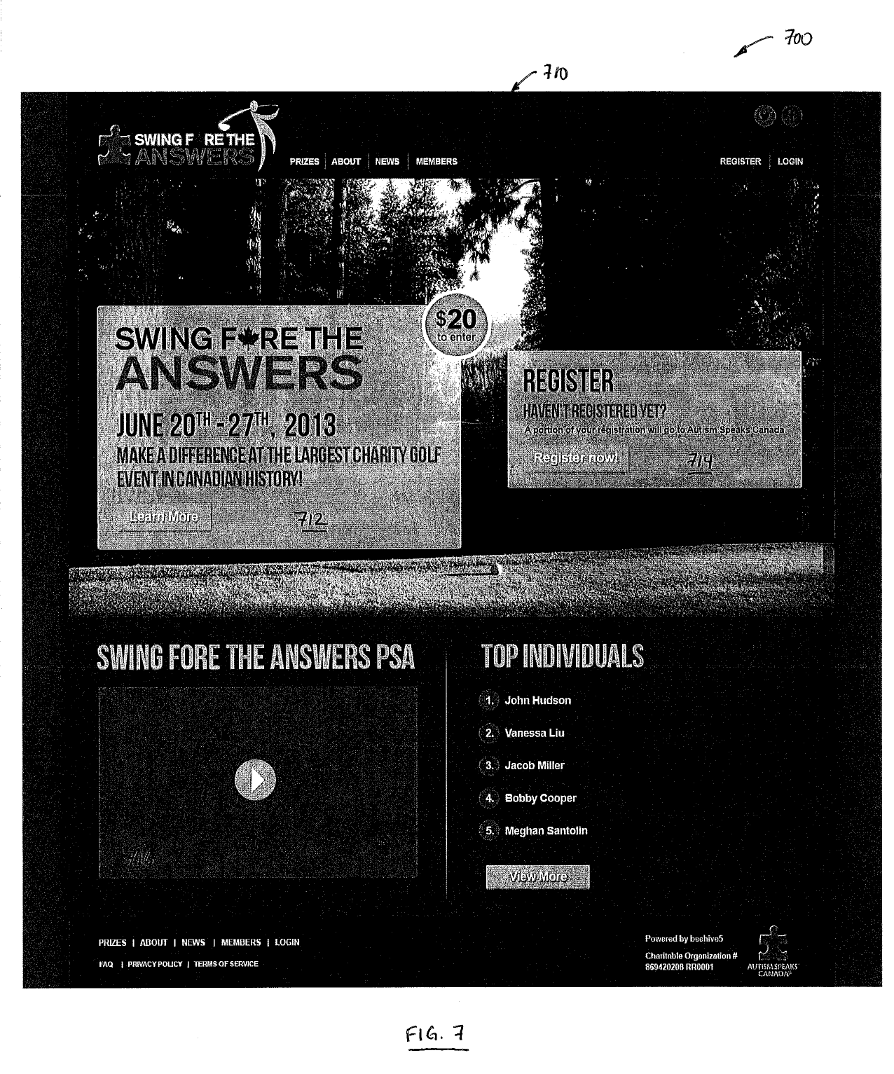

For a donation system, the base website pages module 230 is configured to generate one or more landing pages 330 that are campaign specific to the event (for example, as shown for the screenshot of FIG. 7 and described in more detail below). The landing page 330 provides a customized website specific to the campaign and may include custom logo's, colours and other graphical and style elements, game information, geographical information, etc. According to another aspect, the landing pages 330 are generated with custom branding as indicated generally by reference 332. An exemplary landing page according to an embodiment is depicted in FIG. 7 and described in more detail below.

For a donation system, the incentive/coupon module 250 is configured to be event specific. According to an embodiment, the incentive/coupon module 250 includes prizing and donation tracking indicated generally by reference 350. The prizing and donation tracking 350 is configured to be linked to fundraising and the tools and applications available through a charity's specific donation system indicated generally by reference 352. For instance, the charity's donation system 352 may include a tax receipting module or facility. This functionality can be integrated or linked with the landing page 330 or other customized webpages associated with the specific event (i.e. event property for the charity).

According to another aspect, the social media engine 260 is configured to generate one or more social media campaigns, indicated generally by reference 360 in FIG. 3. The social media campaigns 360 may include unique campaigns, contests, supporting or linking to website applications (e.g. a Facebook™ page) to drive or direct traffic to the event landing page, and may also utilize radio, TV and print advertising and promotion to engage communities.

Embodiments according to the present invention will now described in further detail by way of an example to a charitable fundraising event “Autism Speaks”, and with reference to a set of screenshots or pages that would be displayed to clients and/or users of the system. The screenshots and pages comprise exemplary information, functions and features used by a client for arranging an event utilizing the system and exemplary information, functions and functions used by users (i.e. participants) and/or donors for participating in an event, as described in more detail below and understood by one skilled in the art. For the exemplary Austism Speaks event, the goals of the charitable fundraising are:

raise additional funds for the Autism Speaks Charity

engage a more affluent demographic donor base

create exponentially greater valuable corporate sponsorship program

provide a new national platform for fundraising

Accordingly, the system 100 is configured to create a North American wide golf event for the Autism Speaks Charity as will now be described in further detail.

According to an exemplary implementation, the North American wide event will comprise:
a fundraising tournament that can be played by anyone, anywhere, anytime (i.e. no limit to participants, specific times or location)
when: June 20 to 27
the system is configured to allow golfers (i.e. participants) to register online for $20
for the $20 registration fee, the system is configured to provide each participant with a virtual gift bag of coupons (in excess of $20 registration fee) and redeemable at a variety retailers and/or golf courses (i.e. corporate sponsors 134 in FIG. 1)
each participant plays golf at a course of their choosing. According to the rules for this event, if a participant raises at least $108 (and if they choose to play 108 holes), the player is qualified to win prizes, for example, as listed in Appendix I
according to the event property rules (configured through the system), the players that fundraise the most have the most opportunity to win additional or bigger value prizes, for example, as listed in Appendix I

According to another embodiment, the event property for the event, e.g. golf tournament, is configured to allow participants to compete for prizes based on fund raising solely, i.e. without the requirement to play golf. For example, the participants participate in fundraising only at a location of their choosing, e.g. the office, the living room, the cottage, on a commuter train, etc.

Reference is next made to FIG. 4, which shows a sequence of screenshots for webpages indicated generally by reference 400 generated by the system for the Autism Speaks Charity event including the steps of promoting the event 410, registering participants 420, tracking performance of the participants 430, awarding prizes 440, and determining results and return on event (ROE) and other metrics 450. According to another aspect, the Autism Speaks Charity Event is being branded as “Swing Fore Answers”.

The step of promoting the event 410 comprises generating and promoting invitations to the event. According to an embodiment, the promotion and invitations are generated by the system utilizing digital media through a web portal as indicated generally by reference 412 in FIG. 4. According to another aspect, the event is promoted using emails with embedded links. According to another aspect, the system (i.e. the event property) is configured to utilize display, search, mobile, video and contextual Ad Networks and Exchanges to display digital ads for the event to selected demographics based on their browsing habits, location and/or interests. According to an exemplary implementation, Adwords ads are displayed on Google alongside relevant search results (for example, as indicated by reference 414) and Display Network ads are shown on relevant websites as banner ads (for example, as indicated by reference 416 in FIG. 4). The banner ads are configured to direct the users to customized (and branded) landing pages associated with the event, i.e. “Go Online”, in step 420, and further configured to accept participant registration and donation funds and generate “tickets” and “coupons” for the registered participant as indicated by webpages 422 and 424 in FIG. 4. According to another aspect, the landing pages for each campaign or event are configured to drive potential participants and/or registered participants to take certain actions, such as, make a purchase, sign up for a newsletter and/or connect on social media. For example, the landing page(s) for the event may be configured with sponsor links within the header to provide additional value for key or selected sponsors. Every click on a sponsor link (e.g. a logo with an active link) provides increased brand exposure for the sponsor and directs a portion of traffic back to the sponsor's website.

According to another aspect, the step of promoting the event 410 comprises generating a social media presence to increase support of the event and the associated cause. The system is configured (i.e. the social media engine 150 in FIG. 1) to create and leverage ongoing content to keep the event on “top of mind” and encourage others to spread the word about their fundraising efforts and further encourage others to register for the event.

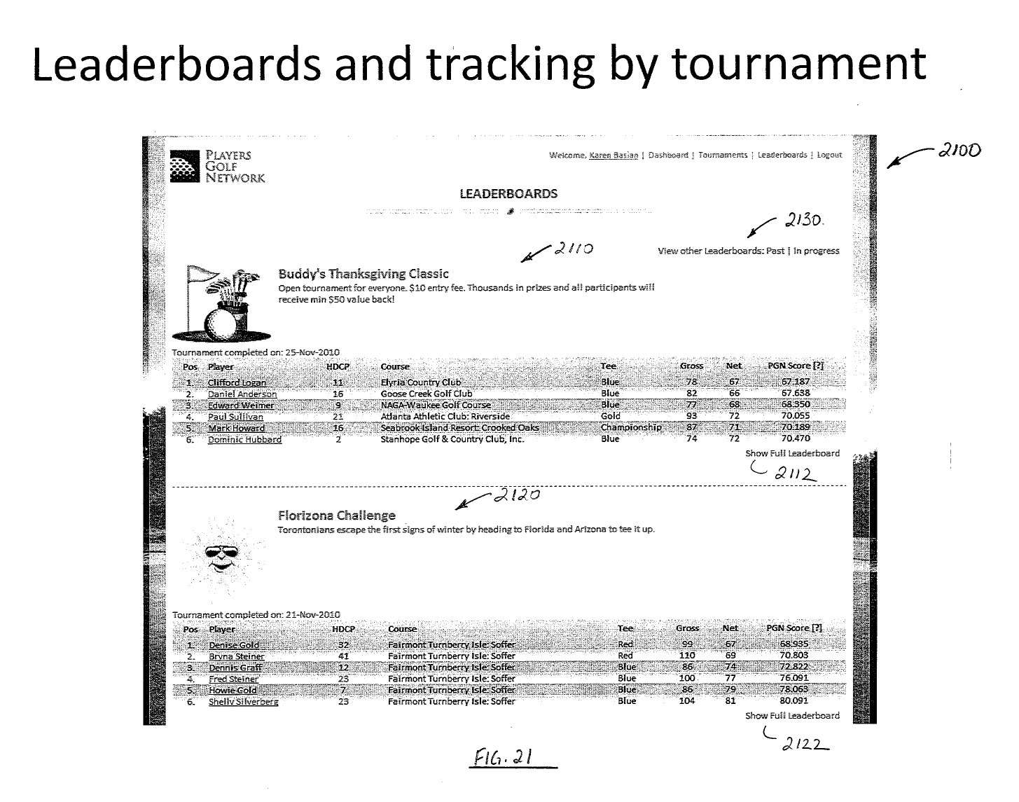

The system is configured to track performance of the participants in step 430. According to an exemplary implementation, the system comprises a “Leader Board” webpage indicated generally by reference 432 which is configured to list the participants in terms of holes played and/or funds raised. A leaderboard according to another embodiment of the present invention is also depicted in the screenshot in FIG. 21.

In step 440 as shown in FIG. 4, the system is configured to generate coupons and other prizes indicated generally by reference 442 for participants based on holes played/scores recorded and/or funds raised through donations.

The step of determining results, ROE (Return On Event) and ROI (Return On Investment), 450 comprises utilizing the analytics and tracking module 260 (FIG. 2).

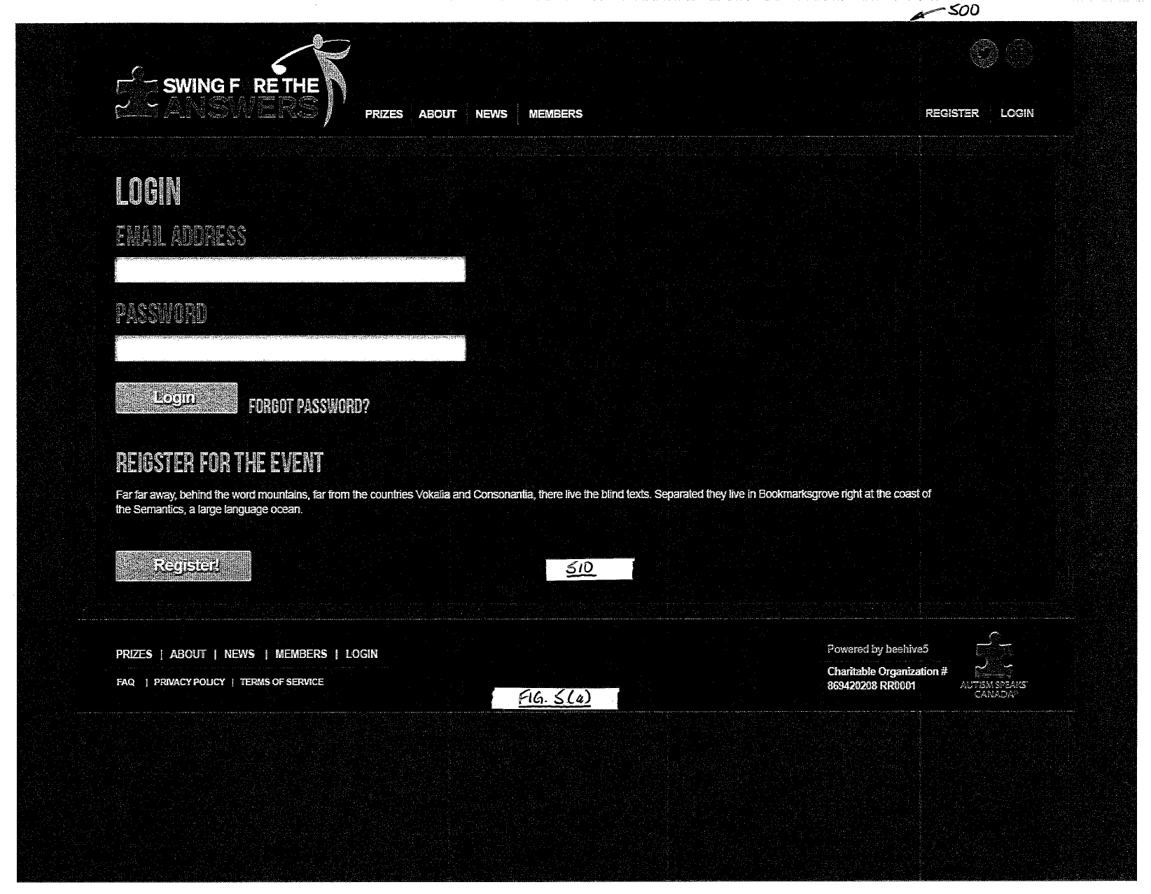

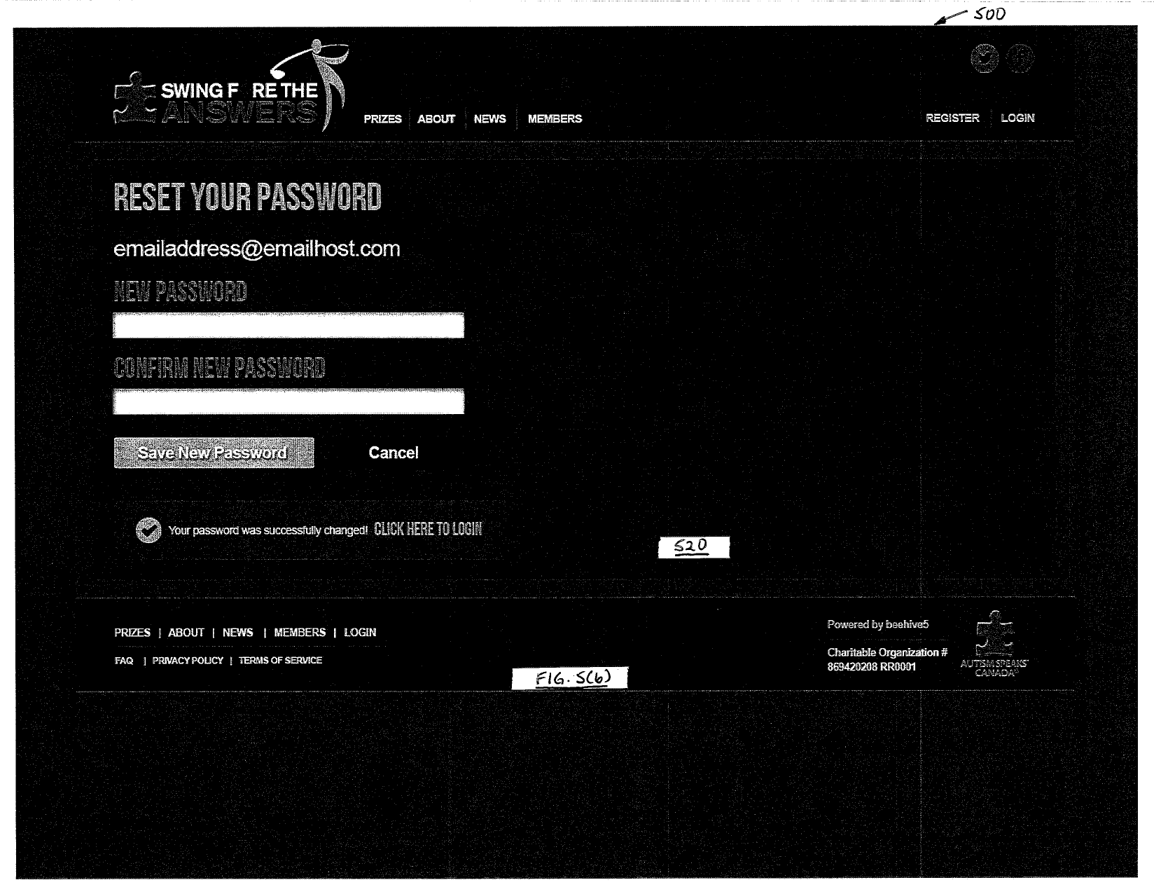

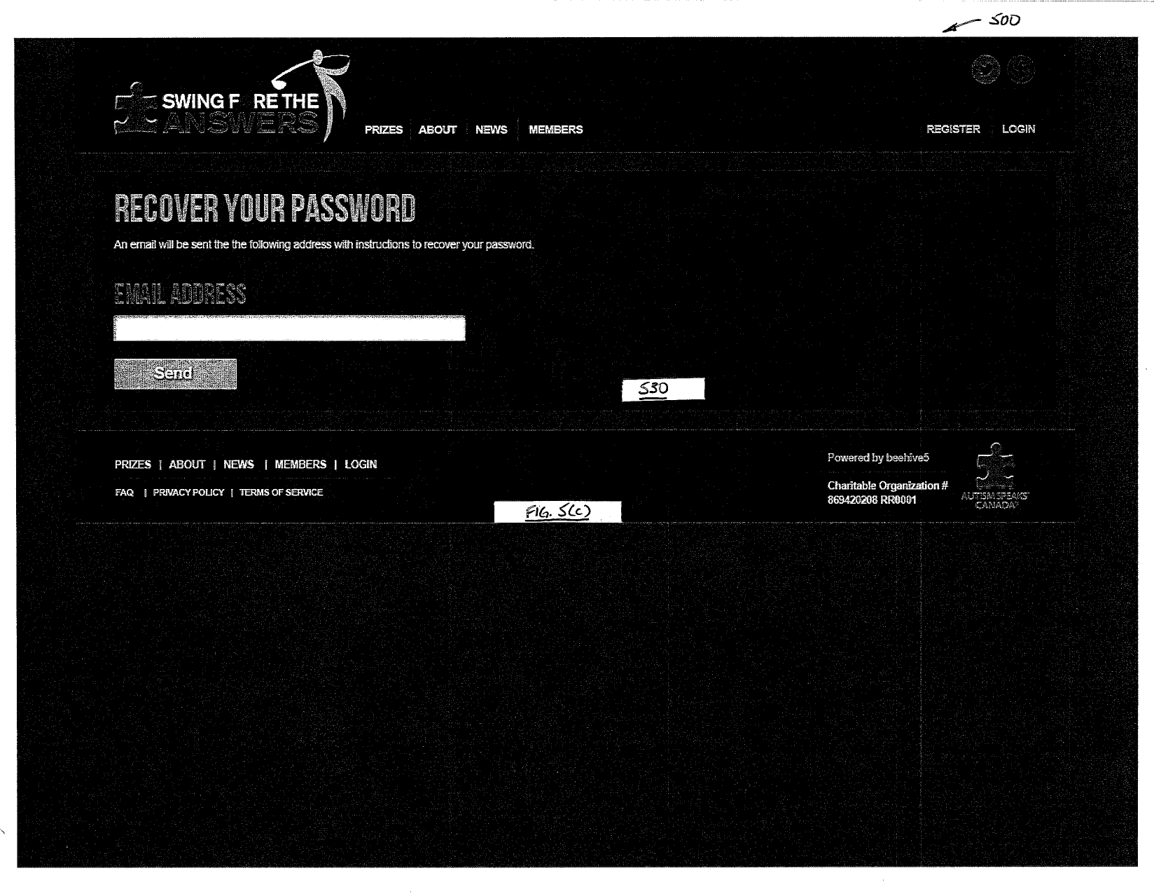

According to an embodiment, the system is configured to generate one or more user-based webpages specific to an event. As shown in FIG. 5, the user-based webpages 500 comprise a “Login” webpage indicated by reference 510 (FIG. 5(a)), a “Reset Your Password” webpage indicated by reference 520 (FIG. 5(b)), and a “Recover Your Password” webpage indicated by reference 530 (FIG. 5(c)).

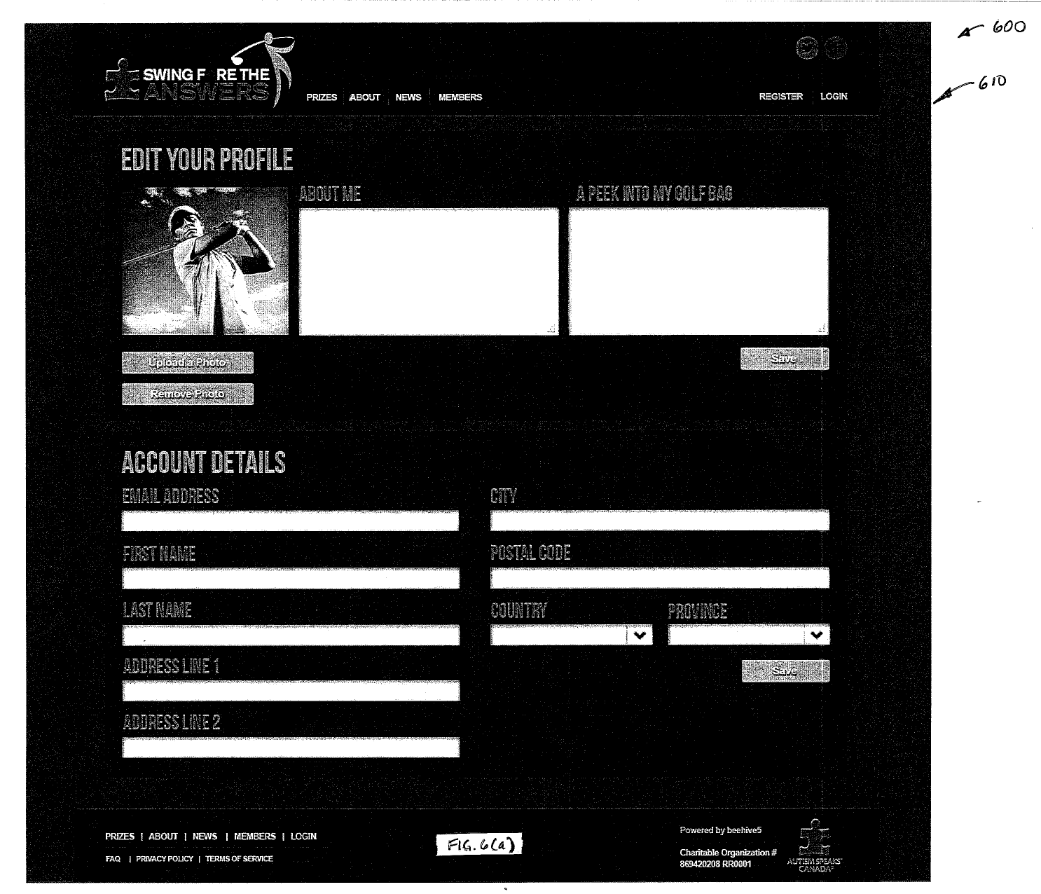

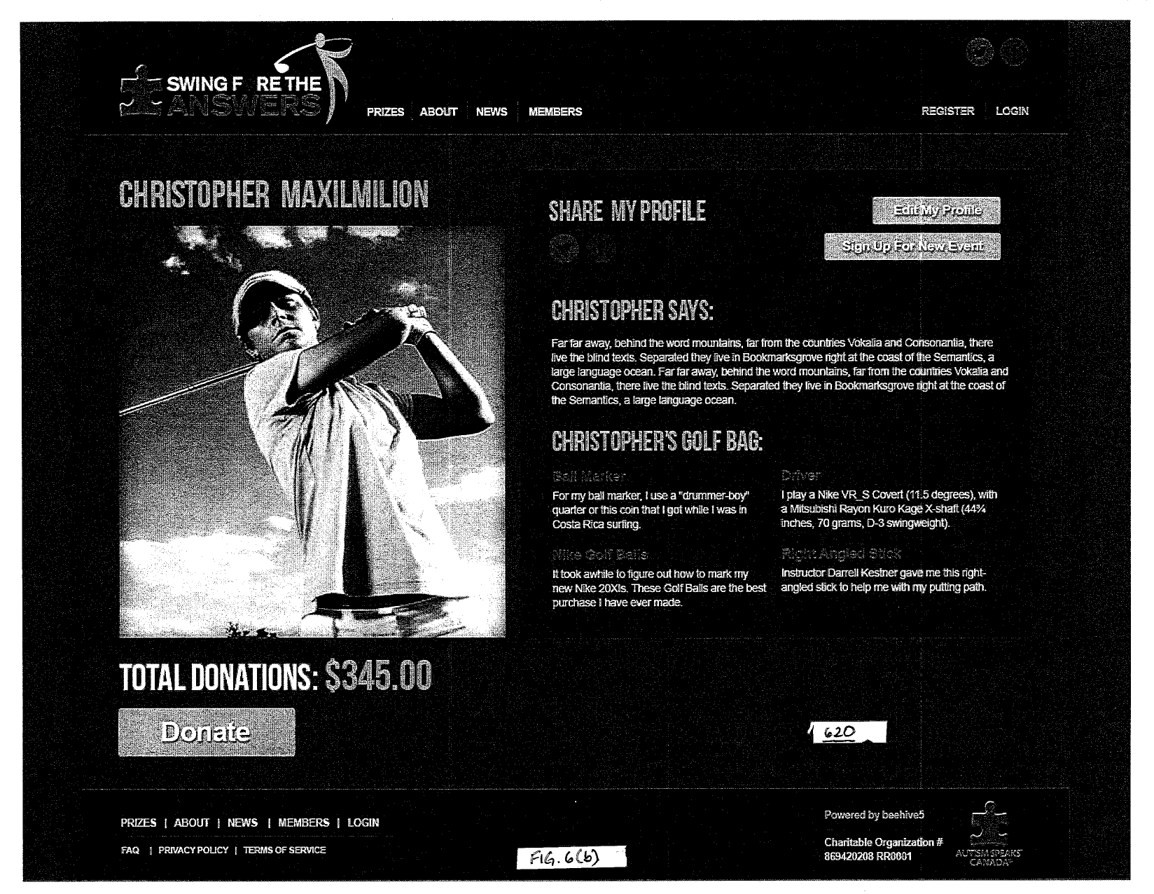

According to an embodiment, the system is configured to generate a member profile for each participant. As shown in FIG. 6, the member profile for a participant (e.g. “Christopher Maximilion”) comprises an “Edit Your Profile” webpage 610 (FIG. 6(a)) and an extended Profile webpage 620 (FIG. 6(b)). The “Edit Your Profile” webpage 610 is configured to allow the participant to edit personal and contact information. The extended Profile webpage 620 is configured to provide additional information about the participant in the context of the event, e.g. “Total Donations: $345.00”, and/or the activity associated with the event, e.g. “Christopher's Golf Bag”. According to another aspect, the extended Profile is configured with a “Donate” button to allow additional donations to be made by the participant, or behalf of the participant. According to a further aspect, the extended Profile webpage 620 is configured with controls to allow the participant to share the profile or selected information on social media, for example, Twitter and Facebook. According to another aspect, the extended Profile webpage 620 is configured with a “Sign Up For New Event” button to allow the participant to join other events running or configured under the system 100.

Reference is next made to FIG. 7 which shows a screenshot of a landing page according to an embodiment of the present invention and indicated generally by reference 700. As described above, the system 100 is configured to generate one or more landing pages for each event (for instance, based on the event properties). As shown in FIG. 7, the landing page 700 comprises the “home page” for an event, and includes an event information window or panel 712, a register window or panel 714, a social media link window or panel 716 and a leaderboard window or panel 718. According to an exemplary implementation, the register panel 714 is configured with a “Register Now” button or control which takes the user to a registration webpage. The social media link panel 716 is configured to allow a user to link to the social media campaign (i.e. Facebook™) associated with the event, and any public service announcements (PSA) associated with the event. The leaderboard window 718 is configured to show the top five participants in terms of donations raised, and includes a “View More” button or control for displaying additional participants and/or displaying a full leaderboard.

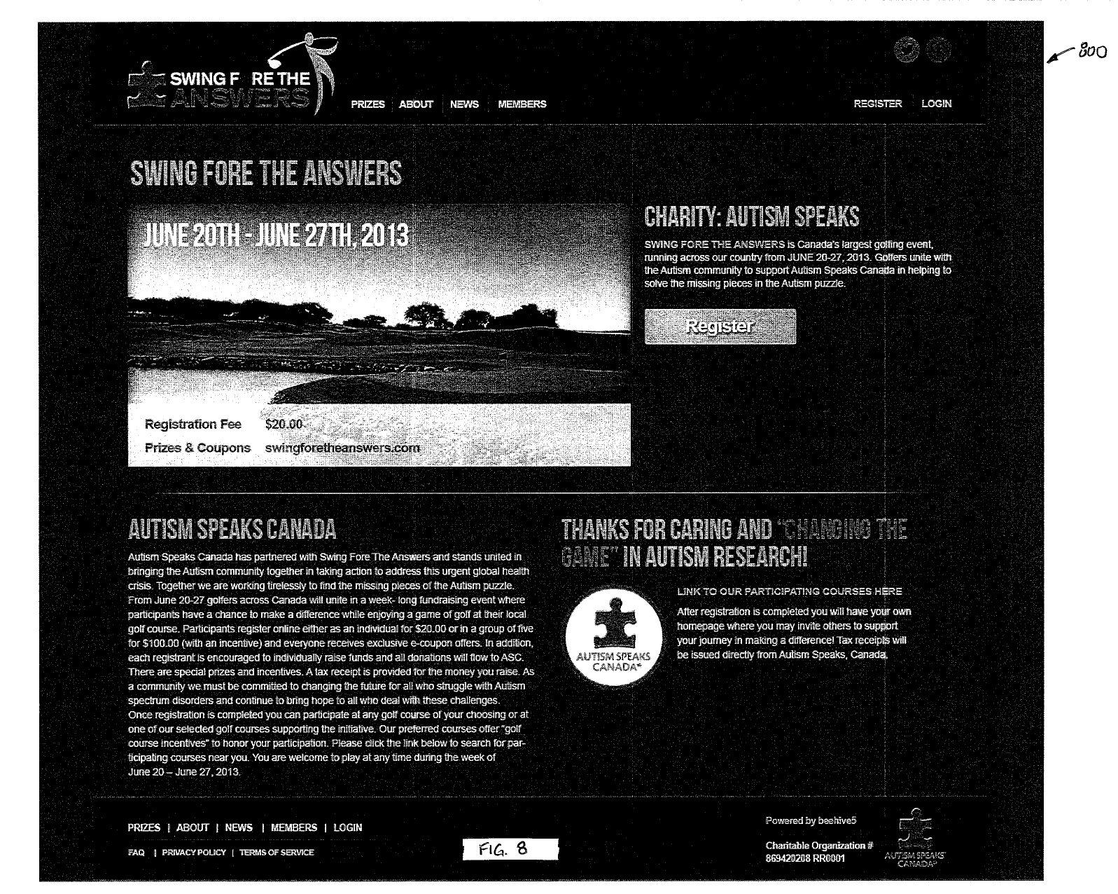

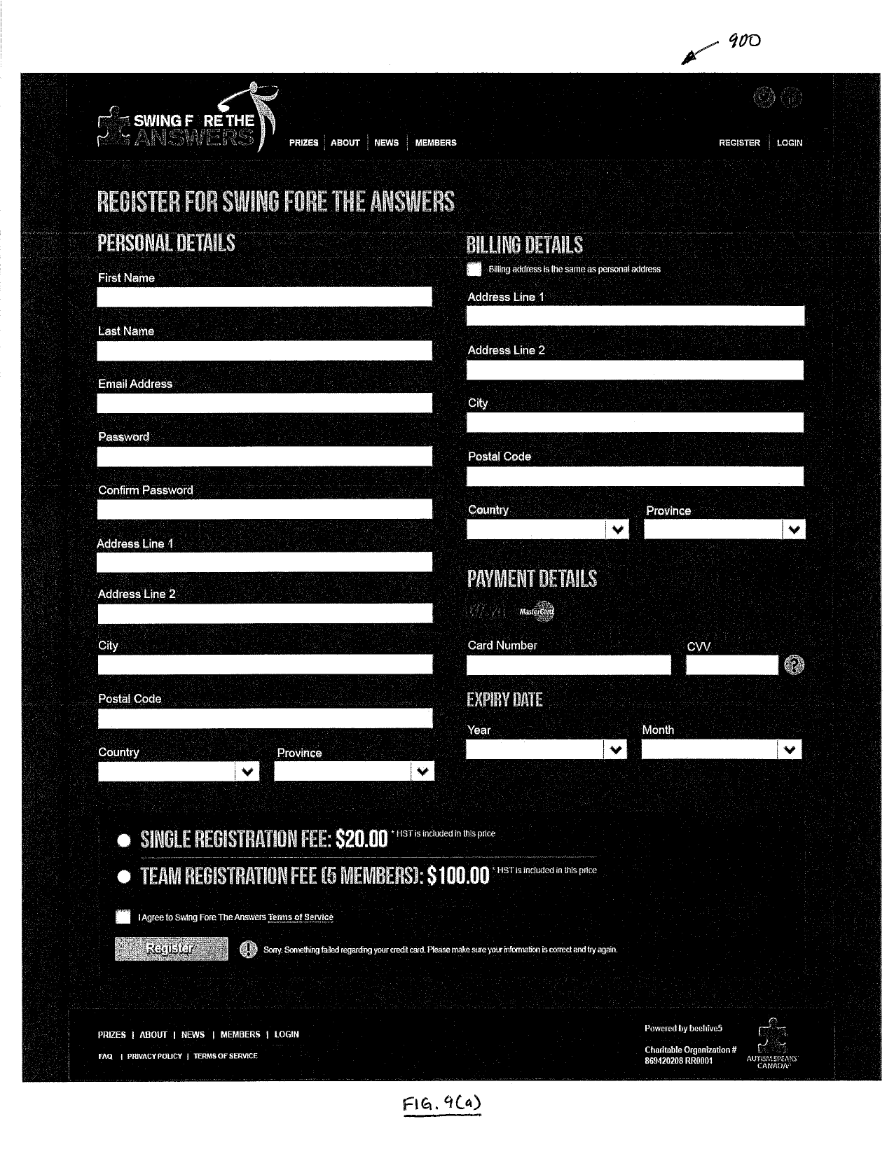

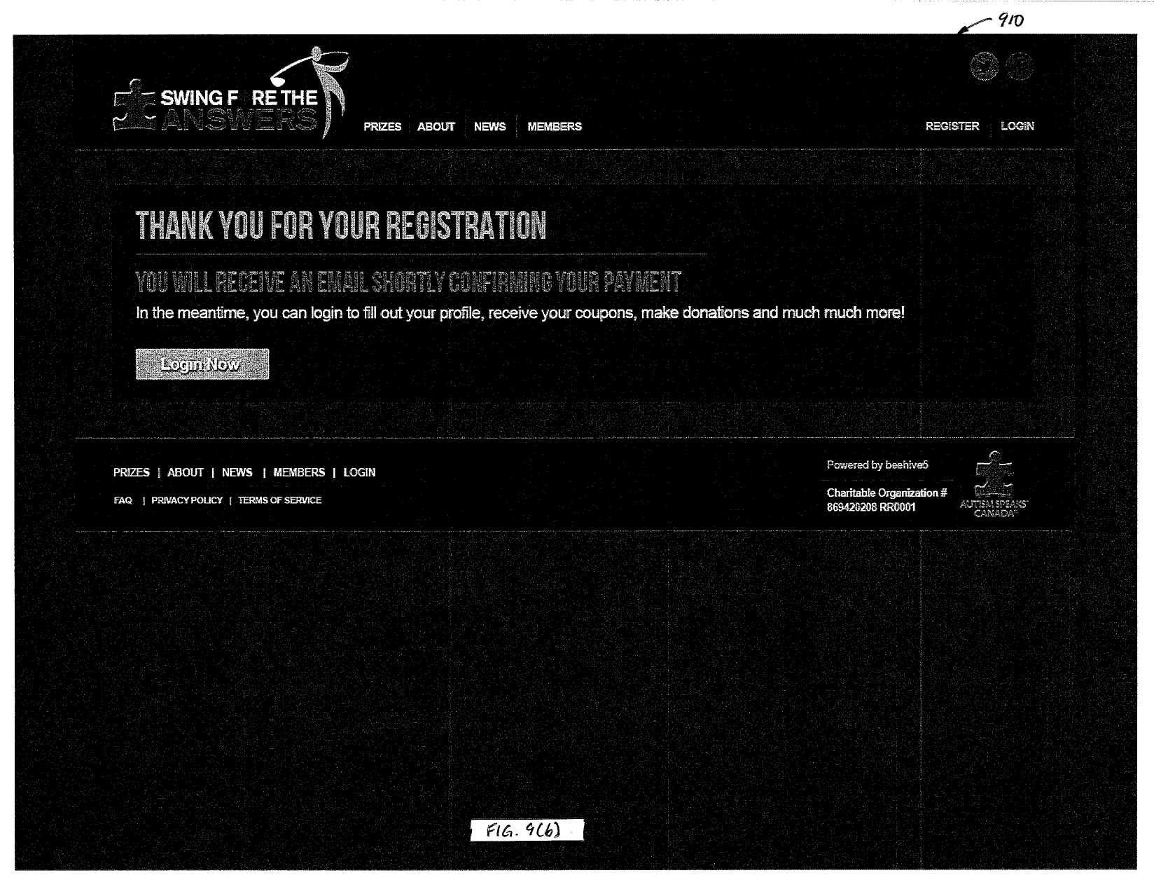

Reference is next made to FIG. 8, which shows a screenshot of an event description webpage indicated generally by reference 800. According to an embodiment, the Event Description webpage 800 is reached from other webpages that are linked through the digital media campaign, for example, through the Google Display Network and other digital media ads. In addition to providing information such as dates, the cause (i.e. Autism Speaks Canada), the event description webpage 800 is configured with a “Register” button or control, which is configured to take the user to a registration webpage for example as depicted in FIG. 9(a) and indicated generally by reference 900.

As shown in FIG. 9(a), the registration webpage 900 is configured with a number of input fields for inputting registration information associated with a participant or user. According to an embodiment, the registration webpage 900 is configured with a payment for making an online payment (i.e. configured to work with the payment gateway module 240 described above in FIG. 2). In response to completion of the registration, the system is configured to generate a registration acknowledgment page 910, for example, as depicted in FIG. 9(b). According to an exemplary implementation, the participant is authorized to access their profile on registration is completed, and a confirmation email is generated and transmitted to the participant once the payment is successfully processed.

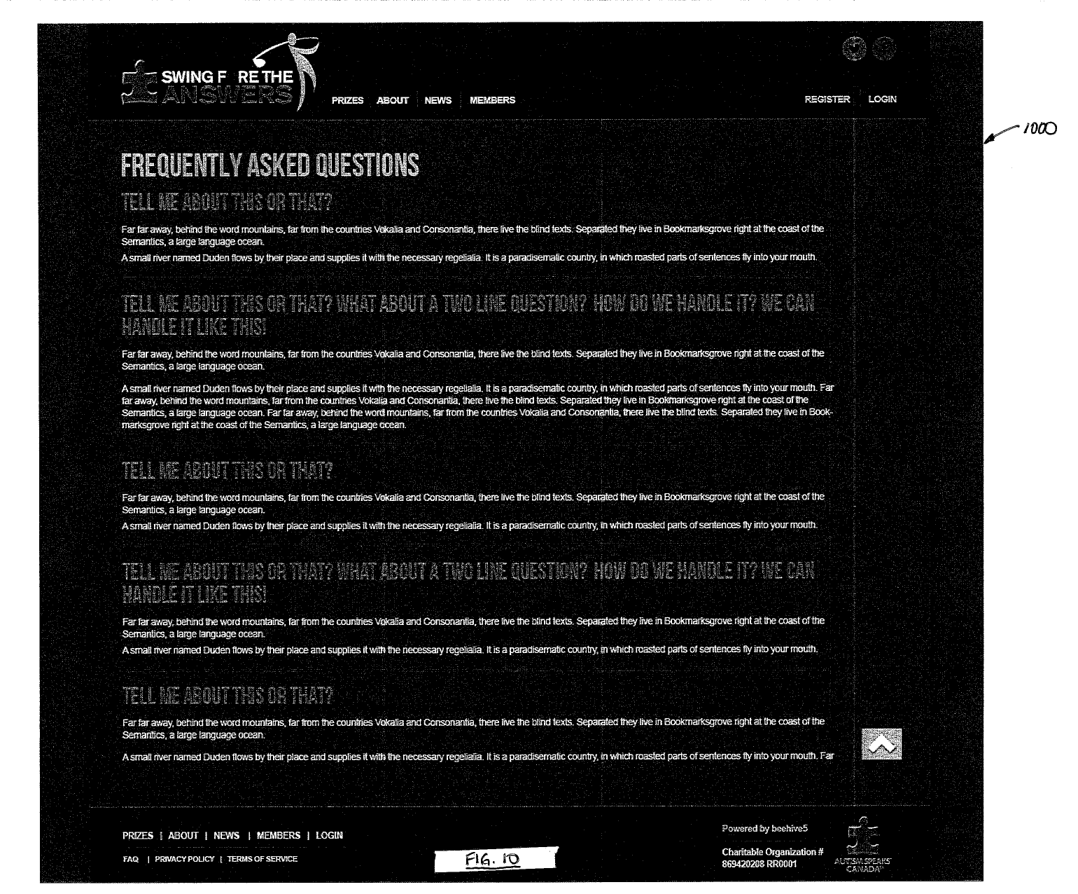

Reference is made to FIG. 10, which shows a screenshot of an exemplary FAQ (Frequently Asked Questions) webpage indicated generally by reference 1000. The system generates the FAQ page based on the nature of event and the associated event properties. According to an exemplary implementation, links are provided to the FAQ page 1000 from the landing page 700 (FIG. 7) and other pages generated by the system for the event.

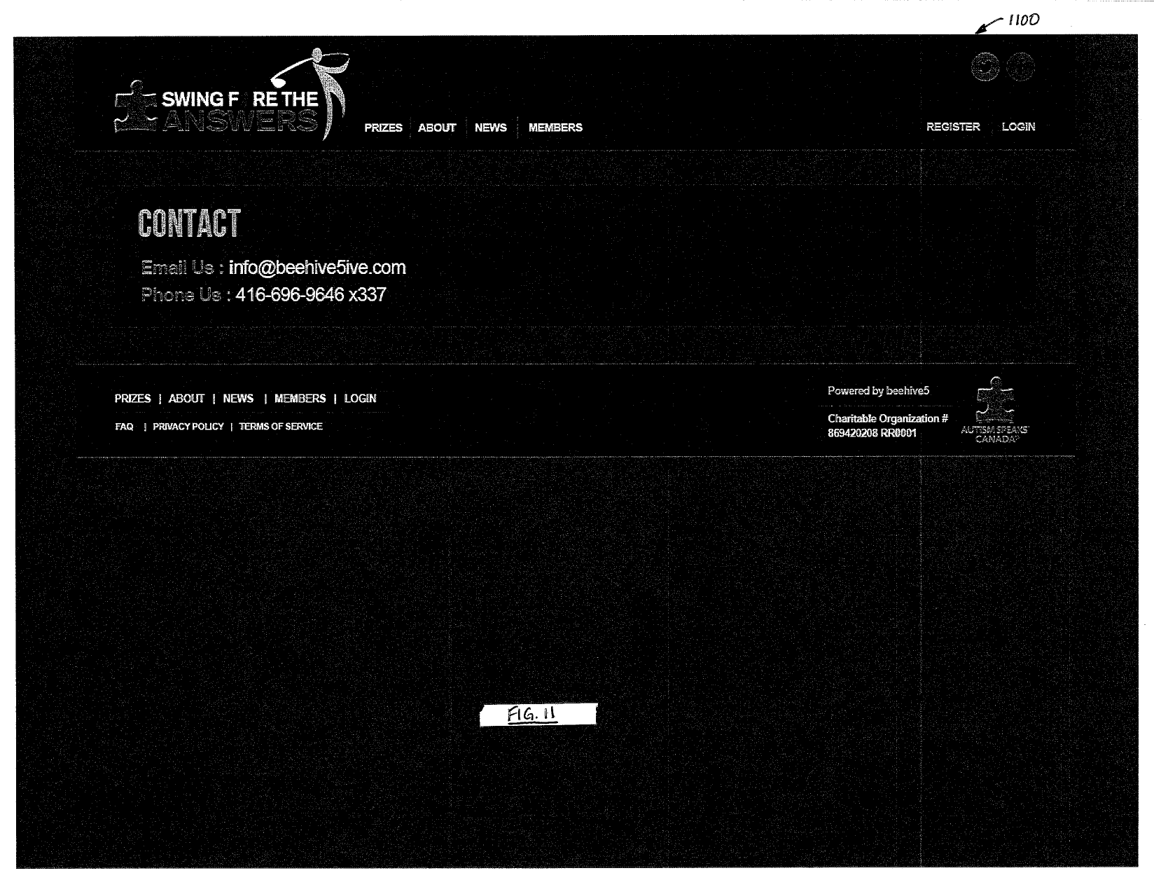

Reference is next made to FIG. 11, which shows a screenshot of a “Contact” webpage according to an exemplary implementation and indicated generally by reference 110. The Contact page 1100 is accessed via a link (e.g. HTML) from one or more of the other webpages.

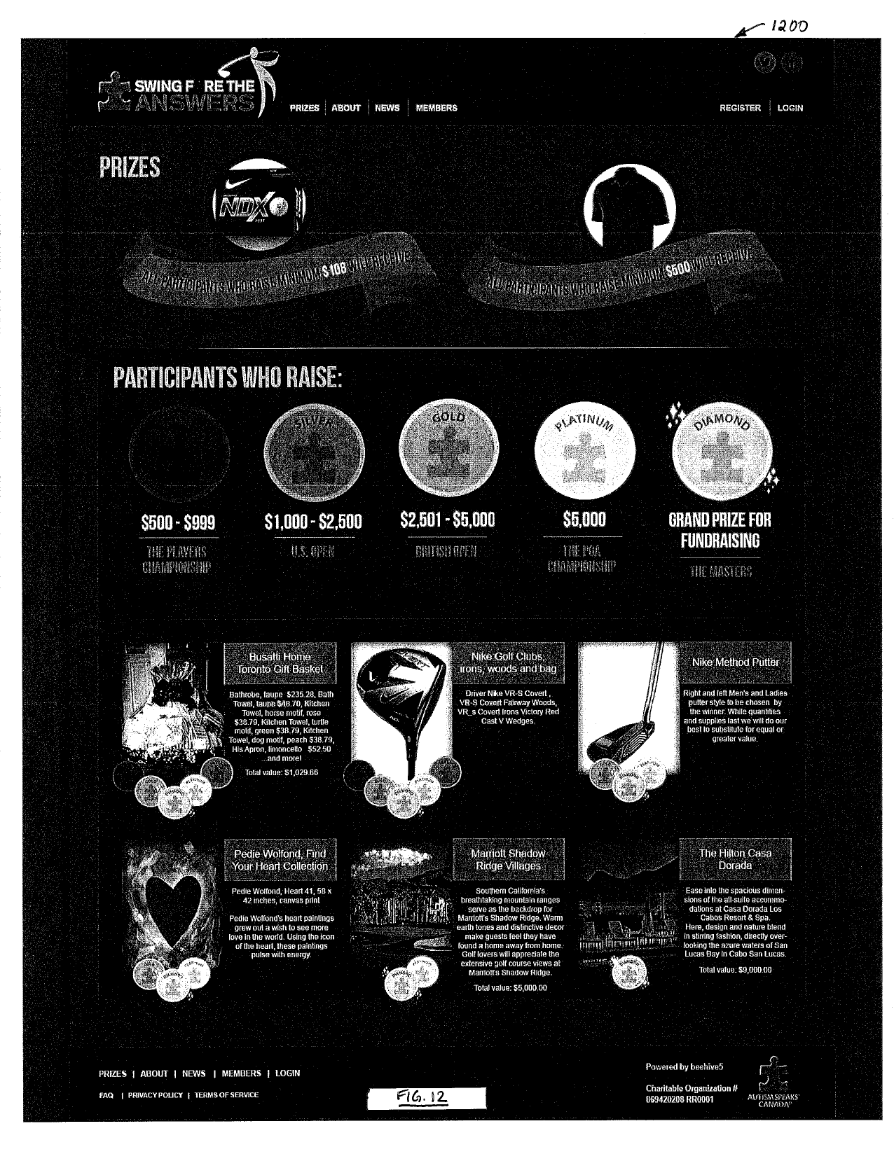

Reference is next made to FIG. 12, which shows a screenshot of a Prizes webpage according to an embodiment of the present invention and indicated generally by reference 1200. The prizes webpage 1200 is configured to work with the incentive/coupon module 250 (FIG. 2). As described above, the incentive/coupon module 250 is configured to create and generate electronic or virtual coupons and other prizes. The prizes page 1200 is configured to generate images of prizes that are available for different levels of participation (e.g. fund raising and/or game play) and/or prizes that are awarded to the overall winner and/or leaderboard winners. According to another aspect, the prizes page 1200 is configured to allow a participant to retrieve coupons based on eligibility. An exemplary prize and incentive structure is outlined in Appendix I for further reference.

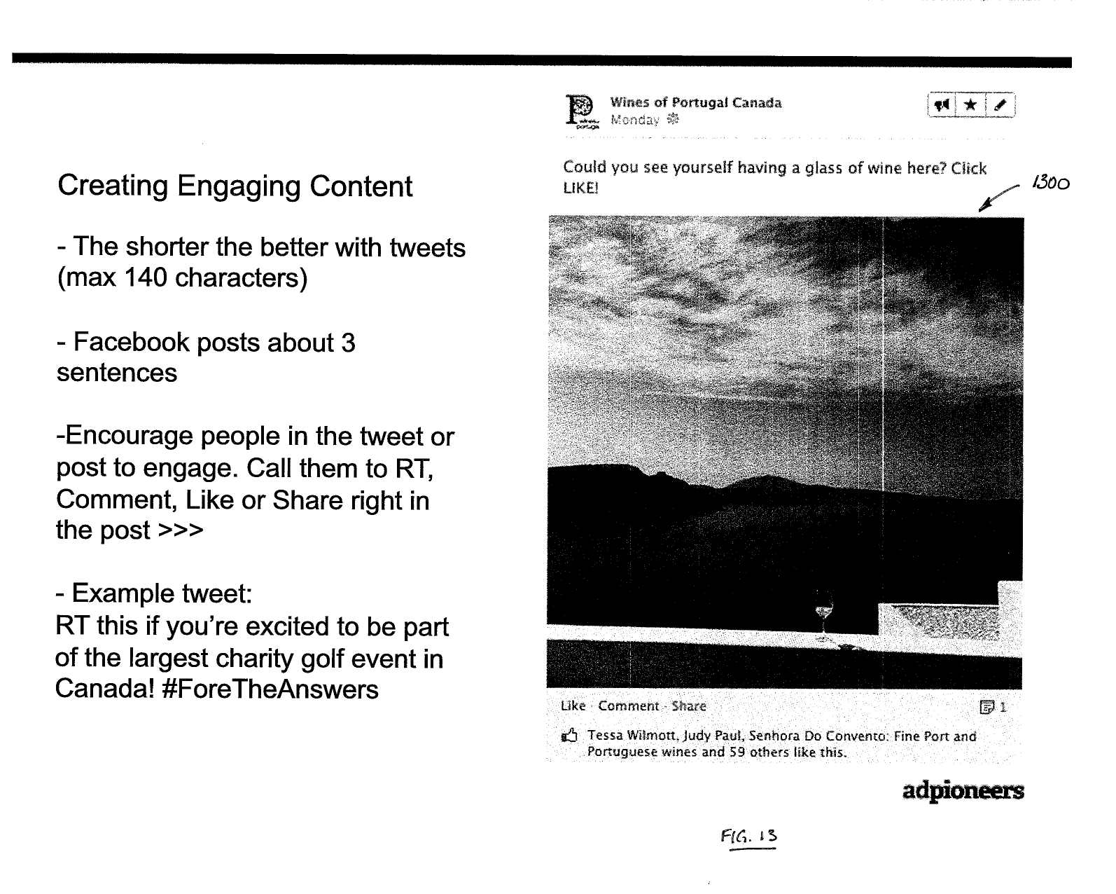

Reference is next made to FIG. 13, which shows a screenshot of an exemplary Facebook™ page for linking the campaign or promotion of the event with social media, indicated generally by reference 1300.

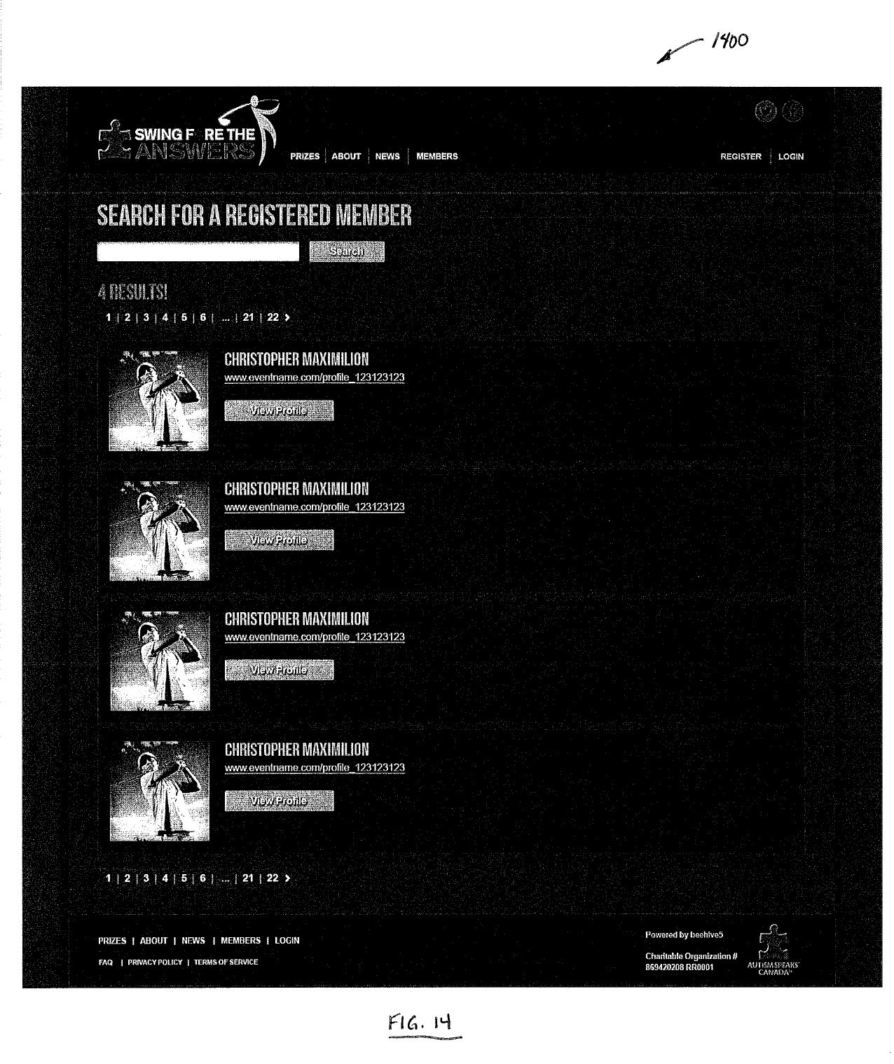

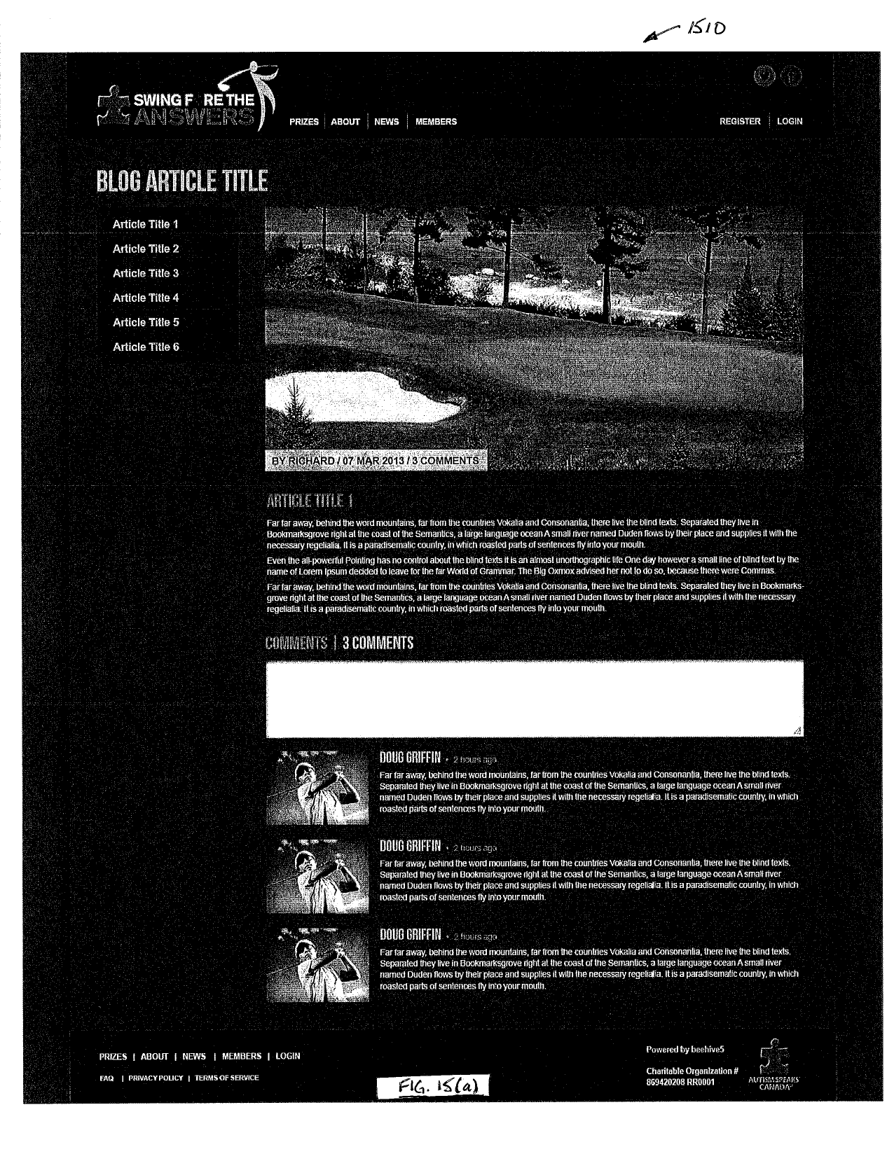

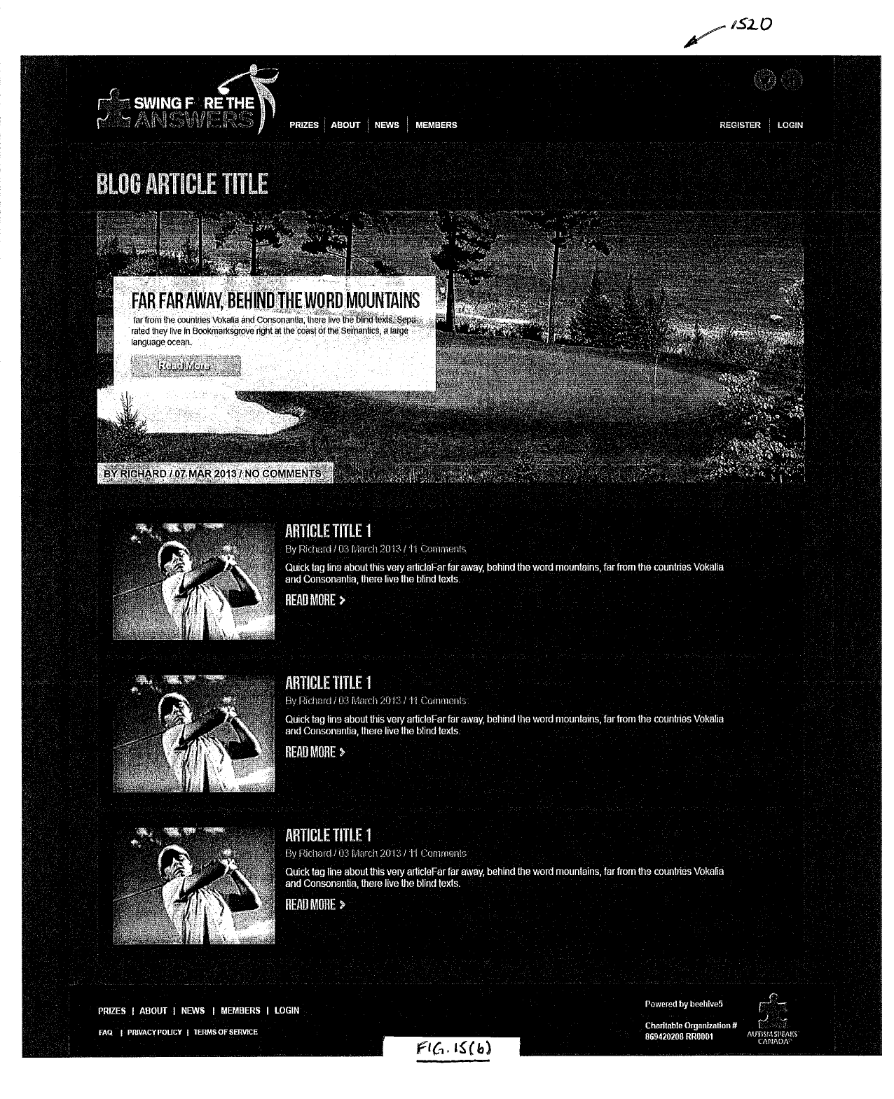

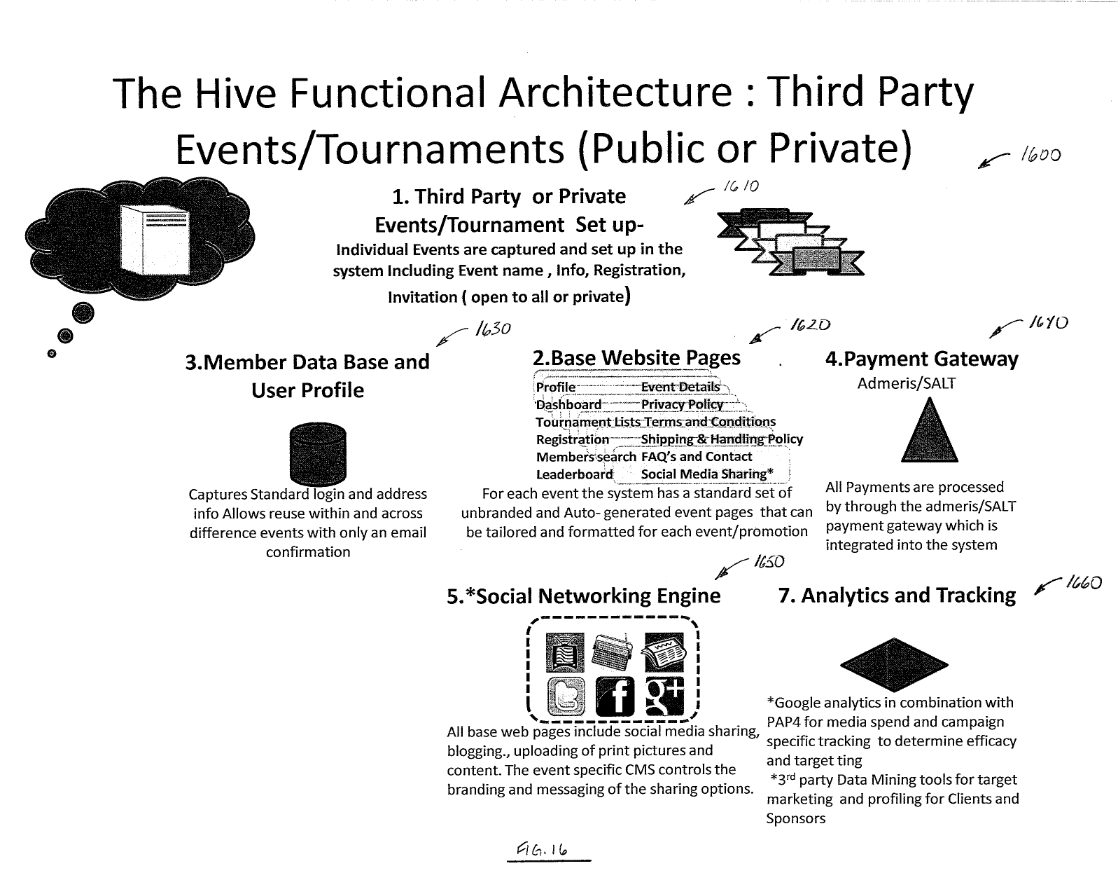

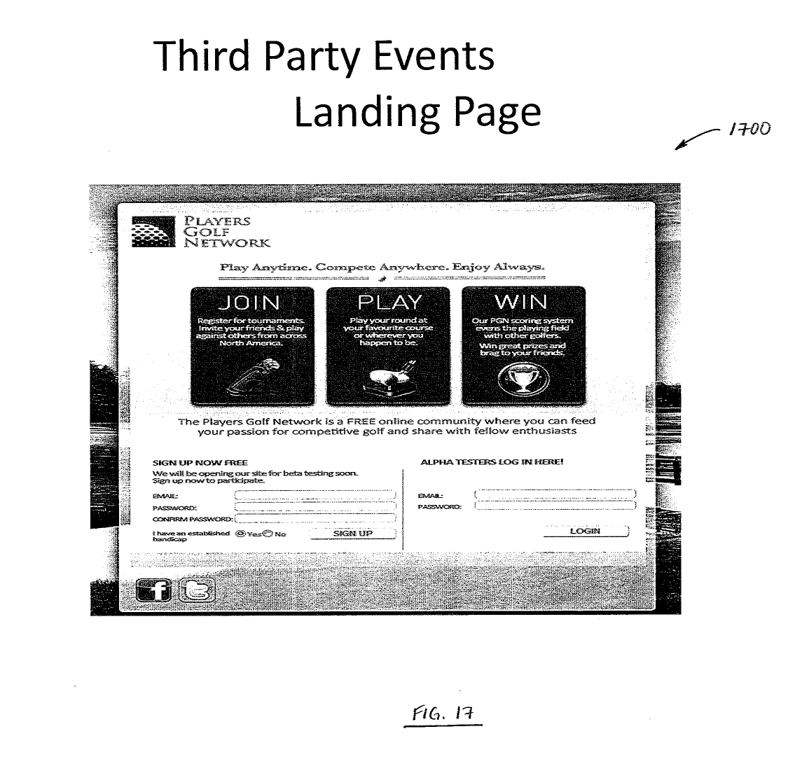

Reference is next made to FIG. 14, which shows a screenshot of a “Search For A Registered Member” webpage indicated generally by reference 1400. According to an embodiment, the search member webpage 1400 is configured to allow another participant to search for other registered participants in the system 100. According to another aspect, the webpage 1400 is configured to allow a participant to view the profiles of the other registered participants and leave messages for the registered participant(s).

Reference is next made to FIGS. 15(a) and 15(b), which show exemplary blogging article webpages, indicated generally by references 1510 and 1520. The blogging article webpage works in conjunction with the social media engine 260 (FIG. 2), which as described above is configured to provide a facility for blogging between participants and members. As shown in FIG. 15(a), the blogging article webpage 1510 comprises a list of blogging articles and partially displays the “blogs” or posts associated with “Article Title 1”. The blogging article webpage 1520 is configured to show one of the blogging articles selected from the main blogging article page 1510, for example, “Article Title 1”.

The functionality and features associated with the system and processes and associated functions and logic for event promotion and fund raising, i.e. the server 120 (FIG. 1), the clients 130 (FIG. 1) and the sponsors 132 (FIG. 1) and the users or participants 140 (FIG. 1), i.e. the donors and/or the personal sponsors, and/or the webpages and other user interface pages as described above, and in accordance with the embodiments, may be implemented in the form of one or more software objects, components, or computer programs or program modules in the server and/or the client machines and/or the participant machines wherein machine is understood to comprise a computer, a mobile phone, or other type of computing device. Further, at least some or all of the software code, objects, components or modules can be hard-coded into processing units and/or read only memories or other non-volatile storage media in executable form for execution by one or more processors in the server and/or other components or modules depicted in the drawings. The specific implementation details of the computer code, software objects and/or program modules will be within the knowledge and understanding of one skilled in the art.

According to an embodiment, the server is configured to provide a user with the capability to create a third party event or tournament on the system. The third party event or tournament may be public or private and is implemented and administered in a manner similar to that described above for the charitable fund raising event.

For a third party event, the server is configured as shown in FIG. 16 and indicated generally by reference 1600. The server 1600 comprises a third party event properties module 1610, a base website pages module 1620, a member and user profile database 1630, a payment module 1640, a social networking engine module 1650 and an analytics and tracking module 1660. The modules comprise programs, code modules, software applications and/or objects configured to run on a platform or platforms configured for the server 1600 (or as part of the server 120 in FIG. 1).

The event properties module 1610 is configured to generate one or more event properties. The event properties may comprise both public and private events. According to an embodiment, each event property on the server 1600 and comprises an “Event” name, event information (e.g. relevant dates, geographical data or information, activity information or definitions, game information), registration information, and invitations (public, i.e. open to all, or private).

The base website pages module 1620 is configured to generate pages, e.g. website pages accessible through a browser application. According to an embodiment, the base website pages module 1620 generates one or more of the following webpages for the third party event property: a profile page, an event details page, a landing page, a registration page, a tournament lists page, a leaderboard page, a dashboard page, a member search page, a privacy policy page, a terms and conditions page, a shipping & handling policy page, a FAQ page, a contact page, and a social media sharing page. According to an embodiment, the pages comprise a set of unbranded pages and auto-generated pages that can tailored and/or formatted for the third party event.

The member data base 1630 is configured to capture and/or store information associated with each of the members or users. According to one aspect, the member data base 1630 is configured to store a user name, login credentials and a profile for each user (i.e. participant). According to an aspect, the member data base 1630 is configured to allow the server 1600 to reuse or transfer user information between separate event properties. The member may also enhance their profile with additional information.

The payment module 1640 is configured to allow participants to make payments (e.g. registration, administration, incidentals, etc.) for events associated with the event properties online via the server 1600. According to an exemplary embodiment, the payment module 1640 comprises a payment gateway such as the Admeris/SALT payment gateway for example as described above. The payment module 1640 is configured to allow participants to make payment online (e.g. utilizing a browser running a computer or other computing device) or via a mobile device (e.g. a smart phone, tablet).

The social networking engine 1650 is configured according to an embodiment to embed or link base webpages for an event property with social media sharing and blogging controls. According to an exemplary implementation, the base webpages associated with the third party event including functional modules and/or controls for social media sharing, blogging, uploading of print pictures and other content. The event specific CMS controls the branding and messaging of the social media sharing options.

The analytics and tracking module 1660 is configured to provide the capability for determining campaign efficacy and targeting. According to exemplary implementation and as described above, the analytics and tracking module 1660 utilizes an analytics application, for example, Google analytics in combination with PAP4, to determine media spend and/or campaign specific tracking. According to another embodiment, the analytics and tracking module 1660 comprises tools for micro-optimization of spend and target marketing for an event. According to an embodiment, the analytics and tracking module 1660 comprises data mining tools configured for user profiles for designing marketing and promotional programs for specific events (i.e. causes), and/or sponsor programs and incentives, and/or for measuring efficacy and returns of an event and associated activities.

As described above, the base website pages module 1620 (FIG. 16) comprises a landing page or web portal page. An exemplary landing page for a third party event according to an embodiment of the present invention is shown in FIG. 17 and indicated generally by reference 1700.

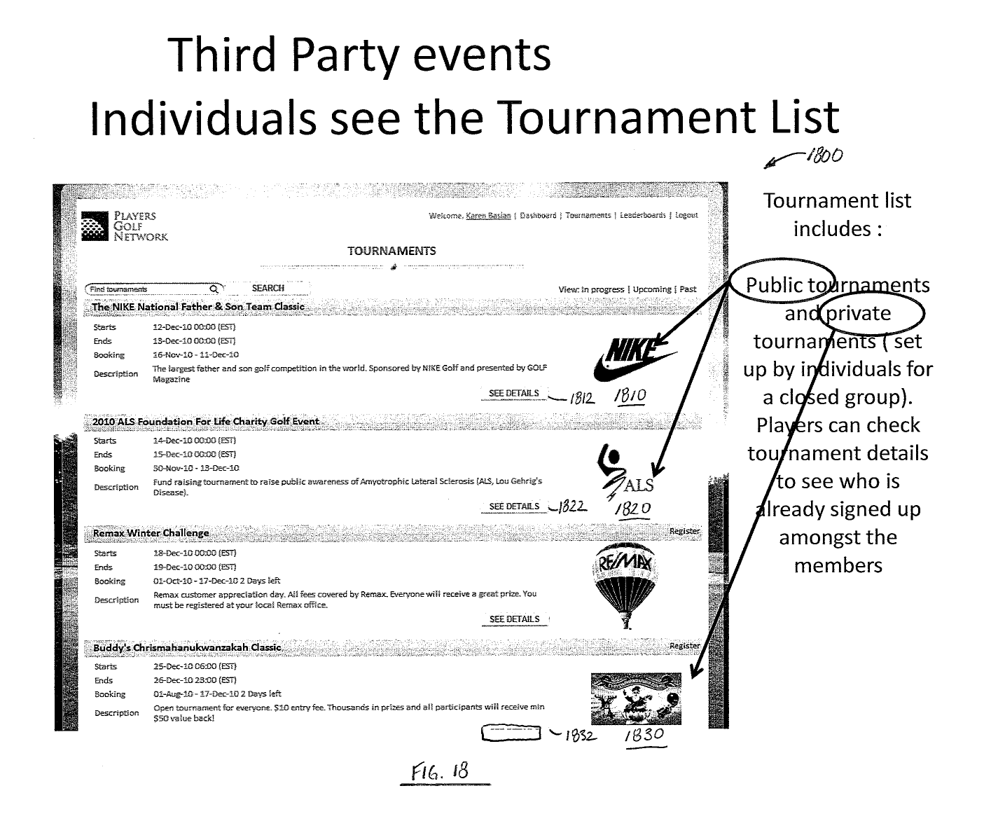

The base website pages module 1620 (FIG. 16) also comprises a tournament list page. An exemplary tournament list page 1800 according to an embodiment of the present invention is shown in FIG. 18. The tournament list page 1800 comprises one or more panels, indicated individually by references 1810, 1820 and 1830 in FIG. 18, with each panel being associated with a tournament or third party event. The first panel 1810 is configured for “The NIKE National Father & Son Team Classic” which is a public event (i.e. open to all), and includes a “SEE DETAILS” 1812 button configured an active control (e.g. clickable button) which allows the user to access another page or window (e.g. pop-up) providing more detailed and additional information about the event. The second panel 1820 is configured for the “2010 ALS Foundation For Life Charity Golf Event”, which is another public event, and also includes a “SEE DETAILS” 1822 for accessing a page or window (e.g. pop-up) with additional information on the event. The panel 1830 is configured for a private event, “Buddy's Chrismahanukwanzahah Classic”. The panel 1830 is configured with a “SEE DETAILS” button 1832, but the system is configured to restrict access to participants that are registered or have an invitation.

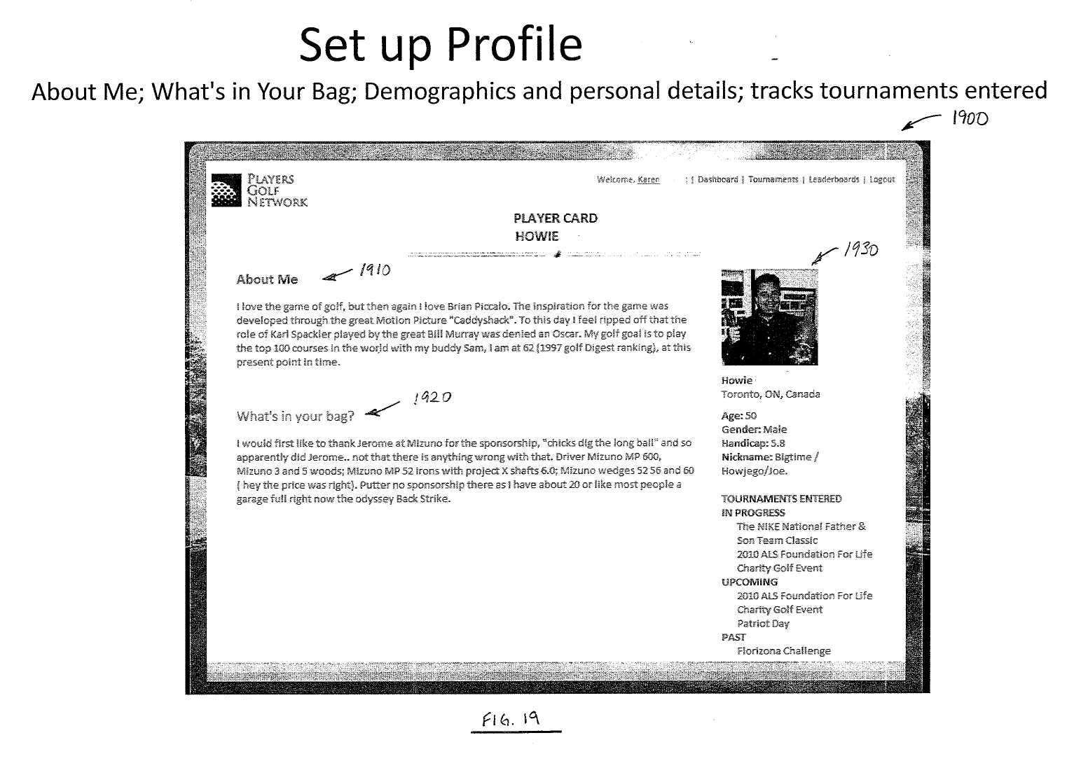

Reference is next to FIG. 19, which shows a screenshot of another base website page comprising a Profile page indicated generally by reference 1900. The profile page 1900 is configured to provide information about a registered user or participant, and according to an exemplary implementation comprises an “About Me” 910 panel, a “What's in your bag” panel 1920, a personal details and demographics panel 1930, and a “Tournaments Entered” panel 1940. The system is configured to update the profile page based on input from the participant and/or tournament tracking.

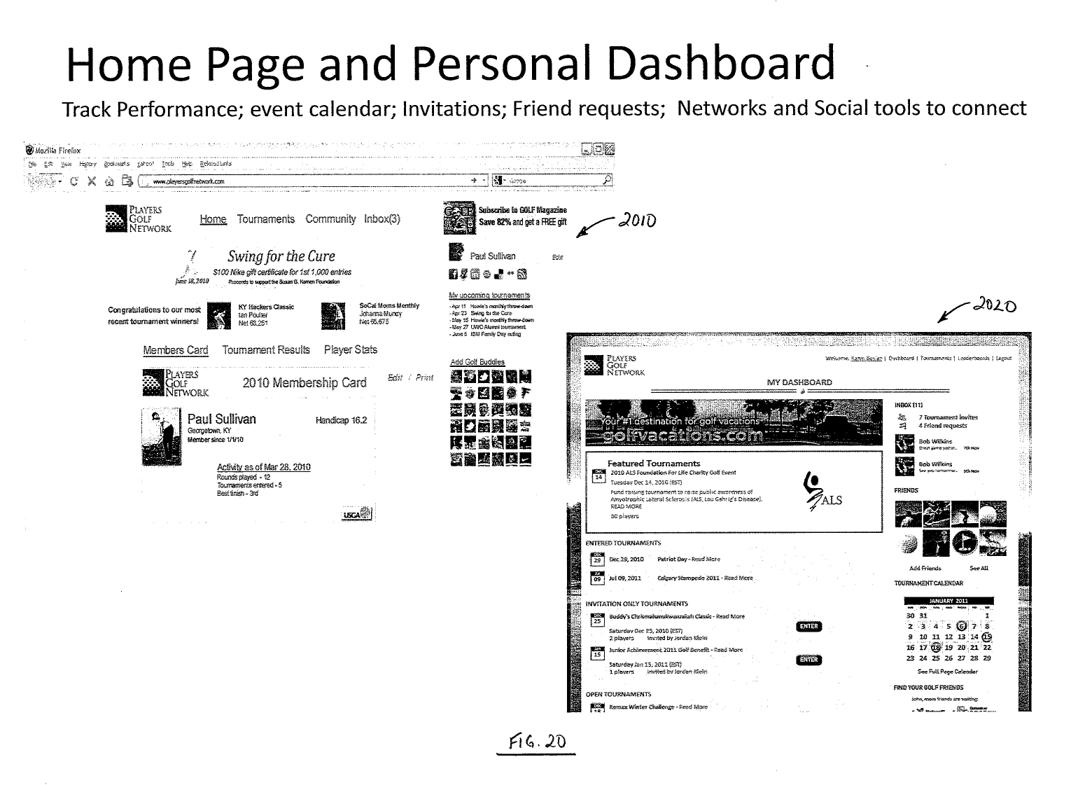

According to another aspect, the server 1600 is configured to generate a home page, for example as shown in FIG. 20 and indicated by reference 2010, and a dashboard, for example as also shown in FIG. 20 and indicated by reference 2020. According to exemplary implementation, the dashboard 2020 is generated for a participant and configured to track performance, provide an event calendar, display invitations and friend requests and provide an interface or link to social tools, such as Facebook.

Reference is next made to FIG. 21, which shows a leaderboard page according to an embodiment of the present invention and indicated generally by reference 2100. The leaderboard page 2100 depicted in FIG. 21 is configured to show two events: “Buddy's Thanksgiving Classic” event, indicated generally by reference 2110, and the “Florizona Challenge” event, indicated generally by reference 2120. The leaderboard page 2100 includes controls (e.g. user clickable buttons or links) for viewing other leaderboards including “Past” and “In progress” events, indicated generally by reference 2130. Each leaderboard 2110 and 2120 includes a “Show Full Leaderboard” button, or user activated control, indicated by references 2112 and 2122, to access a page showing the full leaderboard for the associated event.

According to an exemplary implementation, a user accesses the website and reviews the posted events and selects and joins one of the existing events, or the user sets up their own third party event (e.g. public or private) and invites others to participate. To enroll in an event, a participant registers (e.g. signs up on the website) and sets up their profile. The website (i.e. the system) is configured to provide the participant with a Dashboard which is further configured to show the events in which the participant is enrolled and may further include a calendar. According to another aspect, the system is configured to allow a participant to invite others to join the events, and also maintain contact through the participant's social networks such as Facebook and LinkedIn. According to another aspect, the system is configured to allow a participant to see other participants enrolled in the event and also view their associated member profiles.

In summary, the system according to the embodiments of the present invention provides a mechanism that allows participants in an event, for example, a charity golf tournament, to play at whatever golf course they choose and within a range of time as determined by the charity. Instead of 144 golfers, one day, one location, the event can comprise 144,000 thousand golfers playing 1000 courses all around the world over a few days or a week. According to another aspect, the system is configured to provide participants with detailed scoring, and the ability to share with their friends through social media sites. According to another aspect, the system is configured to provide sponsors with the capability to interact with participants, for instance, before, during, and/or after the event. In addition, the system is configured to generate metrics for use by the sponsors and decision making. According to another aspect, an event or promotion configured for the system can retain a larger percentage of the funds raised. According to another aspect, the system is configured to provide an organization, e.g. a charity, the capability to maintain an ongoing connection with the participants, for example, sharing feedback on their efforts and inviting them to participate in future events. According to another aspect, the system is configured to allow participants to interact with one another, for example, sharing scores, pictures, idea, and thereby creating a community. The active community can then drive additional revenue from advertising, sponsor promotions, etc. For golf related events, the golf industry benefits from greater participation for an event, redemption coupons for prizes at the pro shop.

The embodiments of the present invention as described above may comprise special purpose or general-purpose computers or computing devices including various computer hardware and logic components. Embodiments of the present invention may also include computer-readable media for carrying or having computer-executable instructions and/or data structures stored thereon. Such computer-readable media may include any suitable media that can be accessed by a general purpose or a special purpose computer or computing device.

By way of example, such computer-readable media includes RAM, ROM, EEPROM and other non-volatile storage, CD-ROM or other optical disk storage, magnetic disk storage or other magnetic storage devices, or any other medium which can be configured to carry or store program or computer code in the form of computer-executable instructions or data structures and which can be accessed by a general purpose or special purpose computer or other type of computing device. When information or data is transferred or provided over a network or another communication connection (either hardwired, wireless or a combination of hardwired or wireless) to a computer or computing device, the computer or computing device properly views the connection as a computer-readable medium. Thus, any such connection is properly termed a computer-readable medium. Combinations of the above should also be included within the scope of computer-readable media.

The computer-executable instructions comprise, for example, instructions and data which cause a general purpose or a special purpose computer, or a computing device, or a processor or a processing device to perform a certain function or group of functions. Although the subject matter has been described in language specific to structural features and/or functional components and/or processing acts or steps, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A system for staging an event wherein a plurality of participants are geographically dispersed, said system comprising:
a server operatively coupled to a communication network and including a participant interface;
each of said participants having a computer device configured to interface with said participant interface over said communication network;
said server being configured to generate an event property for the event, said event property comprising one or more elements associated with the event, and said event property being configured to allow each of said participants to participate in the event from a location of their choosing, and one of said event property elements comprising a date range for participation in the event by each of said participants; and
said server being configured to record the participation of each of said participants.

2. The system as claimed in claim 1, wherein said event property further comprises fund raising, and said server is configured with a fundraising module configured to accept donations for said fund raising.

3. The system as claimed in claim 2, wherein said location comprises a private location accessible by said participant and a public venue open for participation in an activity associated with the event.

4. The system as claimed in claim 2, wherein said participant interface comprises a landing webpage generated for the event, and said landing webpage including a component for registering a new participant and a component for providing access to a registered participant.

5. The system as claimed in claim 4, wherein said landing webpage includes a component for accessing a plurality of venues for participating in the event.

6. The system as claimed in claim 3, wherein said activity comprises any one or more of golf, bowling, walkathon, running race and cycling.

7. The system as claimed in claim 3, wherein participation in the event comprises fund raising by one or more of the registered participants.

8. The system as claimed in claim 2, further including a incentive module, said incentive module including a plurality of incentives comprising coupons for achieving predetermined fundraising objectives or participation objectives as defined in said associated event property, and said incentive module being configured to allow said coupons to transferred to said participants.

9. A computer program product for staging an event wherein a plurality of participants are geographically dispersed, said computer program product comprising:
a storage medium configured to store computer readable instructions;
said computer readable instructions including instructions for,
registering each of the participants for participation in the event;
configuring an event property for the event, said event property comprising one or elements associated with the event, and said event property being configured to allow participants to participate in the event from a location of the participant's choosing, and one of said event property elements comprising a date range for participation in the event by each of said participants; and
recording the participation of each of the participants in the event.

10. The computer program product as claimed in claim 9, wherein said location comprises a private location accessible by said participant and a public venue open for participation in an activity associated with the event.

11. The computer program product as claimed in claim 10, further including instructions for receiving funds from one or more of said participants, and said received funds being designated for fund raising for the event.

12. A method for staging an event, said method comprising the steps of:
registering at least some of a plurality of participants for participation in the event;
generating an event property associated with the event, said event property comprising one or elements associated with the event, and said event property being configured to allow participants to participate in the event from a location of the participant's choosing, and said event property being configured to include a time horizon for participation in the event by said participants; and
recording the participation of each of the registered participants at the selected venue.

13. The method as claimed in claim 12, wherein said event property includes a fund raising element, and further including the step of receiving and processing payments from one or more of the participants for raising funds associated with the event.

14. The method as claimed in claim 13, wherein said location comprises a private location accessible by said participant and a public venue open for participation in an activity associated with the event.

15. The method as claimed in claim 14, wherein said activity comprises any one or more of golf, bowling, walkathon, running race and cycling.
